(19) United States
(12) Patent Application Publication
(10) Pub. No.: US 2023/0202874 A1
(43) Pub. Date: Jun. 29, 2023

(54) Method and System for Treating and/or Purifying Water

(71) Applicant: Blücher GmbH, Erkrath (DE)

(72) Inventors: Raik SCHÖNFELD, Erkrath (DE); Charlotte FISCHER, Erkrath (DE); Jan-Peter RAISER, Erkrath (DE)

(73) Assignee: Blücher GmbH, Erkrath (DE)

(21) Appl. No.: 16/650,431

(22) PCT Filed: Jul. 2, 2018
(86) PCT No.: PCT/EP2018/067727

§ 371 Date: Mar. 25, 2020

(30) Foreign Application Priority Data
Sep. 27, 2017 (DE) 10 2017 009 037.8
Sep. 27, 2017 (DE) 10 2017 009 038.6
Nov. 8, 2017 (DE) 10 2017 126 118.4

(51) Int. Cl. C02F 1/28; C02F 1/00; C02F 1/52; B01J 20/20; B01J 20/30

(52) U.S. Cl. CPC C02F 1/283; C02F 1/004; C02F 1/52; B01J 20/20; B01J 20/3092; B01J 20/3078; C02F 2001/007; C02F 2209/001; C02F 2301/08; C02F 2101/306

(57) ABSTRACT

The invention relates to a method for preferably continuous treatment and/or purifying of water encumbered by contaminants, in particular organic contaminants, preferably micropollutants and/or trace substances, in particular untreated water, preferably for purposes of producing and/or obtaining treated and/or purified water, in particular pure water, preferably drinking water and/or service water. The invention further relates to a water treatment system for carrying out said method and to applications thereof.

### CROSS-REFERENCES TO RELATED APPLICATIONS

This application is a National Stage filing of International Application PCT/EP 2018/067727, filed Jul. 2, 2018, entitled “Method and System for Treating and/or Purifying Water”, claiming priority to DE 10 2017 009 037.8, filed Sep. 27, 2017, DE 10 2017 009 038.6, filed Sep. 27, 2017, and DE 10 2017 126 118.4 filed Nov. 8, 2017. The subject application claims priority to PCT/EP 2018/067727, DE 10 2017 009 037.8, DE 10 2017 009 038.6, and DE 10 2017 126 118.4 incorporates all by reference herein, in their entirety.

### BACKGROUND OF THE INVENTION

The present invention concerns the technical field of the treatment/purification of water, especially of water—such as raw, untreated water—that is used for production of tap water or service water.

The present invention more particularly relates to a method for preferably continuous treatment/purification of water polluted with contaminants, preferably for purposes of recovering/obtaining treated/purified water, such as tap water or service water, for example, where the contaminants are removed adsorptively from the water to be treated or purified, this being the case preferably for increases in the concentration of the contaminants in the water to be treated or purified, these concentration increases more particularly occurring for a limited time/spontaneously.

Furthermore, the present invention also relates to a water purification plant, especially for preferably continuous treatment/purification of water polluted with contaminants. In this context the present invention also relates to a total water purification plant which comprises the purification plant according to the invention.

Furthermore, the present invention also relates to a use of the water purification plant of the invention for preferably continuous treatment/purification of water polluted with contaminants.

The present invention also, moreover, relates to a use of the water purification plant according to the invention as a constituent of a total water purification plant for preferably continuous treatment/purification of water polluted with contaminants.

The present invention also relates, furthermore, to a use of the water purification plant of the invention for attenuating/evening-out concentration increases of contaminants, these increases more particularly being time-limited or occurring spontaneously, in a water to be treated and/or purified, or for removing contaminants associated with the concentration increases.

The present invention further relates to a use of the water purification plant of the invention for retrofitting/supplementing existing plants/apparatuses which are used for preferably continuous treatment/purification of water polluted with contaminants.

The generally increasing water-body soiling or water contamination and therefore the soiling of surface water bodies, such as rivers, lakes and oceans, and also of groundwater or tap water, pose a large environment-specific challenge, not least in light of the fact that water in the form of tap water represents one of the most important and irreplaceable means of sustaining life. This is also especially the case in light of the fact that substances which are a direct influence on human health, such as toxic or carcinogenic substances, are introduced into the aquatic environment in a frequently excessive way and may consequently also enter the tap water.

The soiling of bodies of water in this connection may take the form, for example, of direct soiling and hence through direct introduction of contaminants into a water body, as is the case, for example, for the introduction of wastewaters from factories or municipalities, being diverted via the sewer system, for example. There may also be soiling of water bodies by indirect introduction of contaminants, as is the case, for example, for fertilizers or pesticides applied to agricultural land, tire abrasion, salt grit and oils in road wastewaters, or airborne noxiants, which are washed into the water system with the rain. In this context, the groundwater may often also be affected by such soiling. About half of the water body load derives from direct introduction, and the other half from indirect introduction, with the balance nevertheless varying as a function of the specific noxiant under consideration and the body of water that is affected by the soiling.

In this context, a major problem is also posed by what are called microcontaminants, for which a synonymous term is trace substances or micropollutants. These also include, in particular, chemicals utilized agriculturally, such as pesticides, fungicides, insecticides or the like, and also further defined industrial chemicals, such as plasticizers, especially bisphenol A, x-ray contrast media, such as amidotrizoic acid and iopamidol, surfactants, such as perfluorinated surfactants, or the like. Also a factor are active pharmaceutical ingredients or human drugs, such as analgesics, active hormone ingredients or the like, which following administration are excreted unchanged or which, following chemical conversion within the human body, are excreted as conjugates or metabolites and consequently may enter the wastewater/the aquatic environment. Further examples of microcontaminants also include, moreover, what are known as antiknock agents, such as methyl tert-butyl ether (MTBE). Further instances include Dissolved Qrganic Compounds or Dissolved Organic Carbons (DOCs), which may likewise occur as unwanted contaminants in the water. Particularly noteworthy in this context is the fact that the aforesaid substances even in small amounts have a high toxic potential or low biocompatibility and hence for that reason as well even small amounts or contaminations are to be classified as extremely problematic.

The aforesaid substances or classes of substance therefore especially have the feature in common that even on uptake a very small amounts, in the g range or even in the ng range, they may have a considerable influence on the human body/human health, in the context, for example, of hormonal activity, their property as being endocrine disruptors, and the development of resistances or the like. In that respect as well there is a large requirement to remove such substances from the (crude, untreated) water used therein, especially as part of the recovery of tap water.

Moreover, pesticides in particular, such as crop protection compositions, biocides or the like, not least because of increasing intensification of agriculture, are being used in constantly increasing amounts, so also leading to an additional burden on water systems and/or the groundwater by non-negligible amounts of pesticides or pesticide residuals, this being also of importance for tap water production. In view of the toxic potential of pesticides, there are correspondingly exacting requirements in relation to removing these impurities, especially with regard to the parent preparation of (crude) water on which recovery of tap water is based, and where the substances in question must be removed.

In particular, the delivery of pesticides or the like to agricultural land, for example, may lead to corresponding contamination or pollution both of surface water and of groundwater, especially if the substances after their delivery are washed off with rainwater and diverted.

In this context, a corresponding importance is also attached to the pesticide metaldehyde, this being, specifically, a pesticide known as a molluscicide, which is present in slug pellets, for example. In particular as a consequence of excessive use in agriculture, metaldehyde occurs in a sometimes not inconsiderable amount as an impurity in (raw) water to be treated. In Great Britain in the period from 2008 to 2014, for example, more than 1600 tonnes of metaldehyde were used in this context; metaldehyde in particular on account of its physicochemical properties may pass relatively quickly especially into surface waters and also, not least, into the groundwater, as a result of being washed out with the rainwater, and consequently may also be present at correspondingly located tap water recovery plants. Hence in Great Britain, for example, especially during the application time for metaldehyde, which is applied especially in the fall and the winter to agricultural land, the mandated limited values in tap water are oftentimes exceeded, and hence not least for this reason as well there is a great demand for effective preparation and purification methods, and relevant apparatus/plants.

Furthermore, human drugs, particularly because of the demographic transformation and rising individual life expectancy, with the associated increased consumption of pharmaceuticals, will get into the environment via communal wastewater pathways in an even greater amount and number in the future, this being similarly true of veterinary drugs because of the general increase in meat consumption, with the associated forms of animal husbandry.

Moreover, pharmacologically active substances which are used in veterinary medicine may similarly get into surface water bodies and also into the groundwater, for example as a result of delivery of correspondingly contaminated slurry and subsequent leaching of the agricultural land they are used to fertilize through precipitation, so that the corresponding microcontaminants may be eluted or rinsed into water body systems or into the groundwater.

In view of the toxicity, persistence, and high bioaccumulation potential of microcontaminants or trace substances and also the increasing use of such substances, there is great demand for effective purification of polluted (untreated) water which is used for producing tap water, especially in a water works before being fed into the tap water grid, especially since the microcontaminants in question, because of their increasing presence in the aquatic environment, are increasingly present or detectable in tap water as well, sometimes in critical amounts.

In this context, the purification or processing of (raw) water for obtaining tap water is often associated with the problem that the contaminants in question, such as (micro)noxiants or trace substances, especially pesticides or the like, are not present in constant amount/concentration in the (raw) water to be processed, but instead are subject to relevant fluctuations, in the form, for example, of concentration increases or rises which occur or are present in a time-limited way or temporarily in the water to be treated or purified and which are also referred to synonymously as peak load concentrations or concentration peaks in the contaminants.

It may, for example, be the case that industrial chemicals delivered onto agricultural land, such as pesticides or the like, are leached out of the soil for example under appropriately severe precipitation and subsequently, in a relatively short time and in large amounts, also enter the groundwater/surface water bodies that are used for tap water preparation, and hence in turn enter into the tap water preparation process. The same thing also applies in principle for other industrial chemicals which, as a result of improper use or extreme events, such as major fires or the like, for example, enter disproportionately into the environment, where they may also lead to corresponding water-body pollution.

In general, therefore, and especially in connection with tap water production, there may be unforeseeable and sometimes sudden concentration increases or rises in contaminants, such as micronoxiants or trace substances, as set out above, in a (raw) water that is to be prepared. The stated concentration increases are generally relatively time-limited, spontaneous events, where the contaminants come about in relatively large quantities within relatively short time periods, this being associated with corresponding problems in relation to their removal, from tap water, for example.

Therefore, the concentration peaks of the contaminants in question also pose a major challenge especially for filter systems or preparation plants that are used in the context of tap water preparation, and which, specifically, must be capable of intercepting/removing such concentration peaks, in order to ensure consistent tap water quality with compliance with the relevant noxiant limits. A particular problem in this context is also the fact that the specific incidence of the concentration increases or rises as such is generally not foreseeable, in terms either of the timing (i.e., when the concentration increases or rises occur), their duration (i.e., how long the concentration increases or rises are present for), or their specific height (i.e., in which particular concentration or amount the contaminants are present). In this regard there is at best a certain tendency for the likelihood of the incidence of concentration increases or rises to go up in winter and/or under heavy precipitation.

To summarize, therefore, it may be stated that contaminants, such as trace substances or microcontaminants, in the form of industrial-agricultural substances (such as pesticides or the like), substances used in industrial medicine (such as pharmaceuticals) and industrial chemicals as such, for example, are present to an increasing extent in aquatic systems as well. The aforesaid substances may also occur in the form of concentration increases or peaks that are difficult to manage in terms of purification in (raw) water used for tap water recovery, and so in this context there is a latent risk of contamination of tap water, not least owing to purification measures in tap water production that have to date often been inadequate and cannot be adapted to the specific pollution situation, in association with a high hazard potential for the end consumer.

As a consequence of inadequate management of spontaneous concentration increases, water preparation in the prior art is associated with a high risk of development of breakthroughs of the contaminants, associated with the concentration increases, the contaminants in question being more particularly in the form of micronoxiants or trace substances, and the breakthroughs occurring into the purified water, specifically also in connection with the use of conventional activated carbon as a filter material or adsorption material, with the possible consequence of undue contamination/pollution and hence of unusuability on the part of the tap water obtained.

As well as the risk of spontaneous breakthroughs on sudden incidence of concentration peaks, an additional risk in the prior art, after a concentration increase of the contaminants has subsided or run its course, and especially when using conventional filter systems or conventional activated carbon as filter material or adsorption material, is that of unwanted release or desorption of contaminants previously retained or adsorbed, with release of previously captured noxiants back into the water to be purified. The desorption of noxiants which have already been adsorbed is brought about—without wishing to be confined or defined by this theory—in particular by the concentration drop that occurs of the contaminants in the water to be treated, after the concentration increase has run its course, and the associated shift in equilibrium between contaminants present in the water, on the one hand, and contaminants bound or adsorbed on the activated carbon, on the other. This problem as well has not to date been satisfactorily solved in the prior art.

In general it is possible, for increasing the filter efficiency/purification efficiency, especially in the presence of the concentration increases in question, to attempt to reduce the water throughput and/or to increase the dwell time in the relevant filter system, although this is detrimental to process efficiency and also does not always lead to the desired purification quality. It is also possible to attempt to permanently increase the filter capacity or adsorption capacity as such, although this is technically complicated and economically disadvantageous. Furthermore, the aforementioned approaches may also not counteract the desorption problem referred to.

In general, numerous approaches have been pursued in the prior art on the basis of freeing polluted water, especially (raw) water for the recovery of tap water, from micronoxiants or trace substances. However, the known approaches to water purification do not always produce the desired success. In some cases, in particular, with the water preparation approaches of the prior art, it is not always possible effectively to cover spontaneous increases in amounts or concentrations of contaminants, such as micropollutants or trace substances, in an effective way, and so there may be unwanted breakthroughs of noxiants in the purified water.

One approach in the prior art to reducing levels of microcontaminants or trace substances is to carry out chemical decomposition of the contaminants present in a raw, untreated water, by means of oxidation processes, the relevant methods being referred to generally as advanced oxidation process (AOP). This includes, for example, an ozone and/or UV treatment of the water to be purified. Disadvantages associated with these processes, however, are the high energy costs they entail, the cost and complexity of removing residual ozone in the treated water, and the formation of toxic metabolites and/or degradation products. Moreover, the purification conditions cannot always be ideally adapted to sudden peaks in amount or concentration, or be regulated accordingly.

Another approach, furthermore, to the purification of water in the prior art also involves using membrane-based filter plants, in which case, for example, the principle of reverse osmosis (RO) and also of nanofiltration (NF) and ultrafiltration (UF) is employed. However, a fundamental drawback attaching to such purification concepts is that sometimes complex and costly and also maintenance-intensive filter plants must be designed and operated, the operation of the corresponding plants entailing high operating/energy costs. Moreover, highly polluted toxic residues are a frequent result, the disposal thereof posing a further economic and logistical challenge. Other disadvantages are the sometimes low selectivity and also the short operating times/service lives of the filter plants in question, where operation may be disrupted on a prolonged basis by—for example—(micro)biological growth on the membrane. Furthermore, the plants in question feature only limited adaptability of the filter capacity in response to sudden peaks in amount/concentration of the relevant noxiants.

Furthermore, as already mentioned, another method for lowering the content of microcontaminants or unwanted noxiants in water is that of removing the relevant contaminants from the water adsorptively using single adsorption filters based on conventional activated carbon. The corresponding concepts with the technical implementation and the conventional activated carbons often used with them, however, are often disadvantageous in the sense that, because of the filter design in the prior art, sometimes only low filter capacities and equally low operating times/service lives can be provided, or filters are designed with oversizing in order to provide the desired operating times/service lives, this being irrational from an economic standpoint. Moreover, another disadvantage hampering prior-art adsorptive systems for the preparation of water, employing conventional activated carbon, is that the capacity and efficiency of these systems in the scavenging of contaminants occurring as part of peaks in amount/concentration are often not sufficient, and that on this basis it is not possible to counteract the above-described desorption problem, with the possible consequence under extreme conditions of spontaneous breakthroughs of contaminants/noxiants. It may also be the case that noxiant limits to be complied with are exceeded.

In the prior art, therefore, in the preparation of (tap) water, the sufficient removal of contaminants, especially those arising as part of sudden or spontaneous concentration increases, is not always ensured, not even, specifically, with the single adsorption stages that are used in the prior art and that are based on conventional activated carbon, these stages being usable in general as the last or downstream process step in tap water processing plants. These kinds of prior-art purification or preparation plants suffer in particular from a relatively low purification efficiency, which also entails correspondingly low service lives, which is correlated in turn with increased operating costs and reduced cost-effectiveness, owing in particular to the relatively frequent replacement of the adsorption materials employed.

Additionally, the purification or preparation plants known in the prior art are often inefficient in the sense that satisfactory purification of water to be treated cannot be realized, especially with regard to problem materials, such as pesticides, perfluorinated surfactants, such as perfluoroctanesulfate (PFOS), antiknock agents, such as methyl tert-butyl ether (MTBE), x-ray contrast agents, such as iopamidol and amidotrizoic acid, this also being the case in particular in the event of sudden concentration increases in the contaminants listed.

The German utility model DE 88 15 345 U1 relates to a water conditioner, especially for preparing or providing noxiant-free tap water, the water conditioner being equipped with a plate module that operates according to the principle of reverse osmosis.

Furthermore, DE 10 2008 041 164 A1 relates to a method for conditioning water for removing halide ions by oxidative halogenation of an organic compound which is added to the water and subsequently removed, where chlorate, iodate and/or bromate ions that remain in the water are reacted to form the corresponding halide ions, whereby a further oxidative halogenation is intended.

Moreover, EP 1 044 928 A1 relates to a water treatment process which comprises the addition of ozone to raw water and the filtration of the raw water using an ozone-resistant membrane, where the filtrate may further be treated with activated carbon or with a reverse osmosis membrane.

### BRIEF SUMMARY OF THE INVENTION

With the approaches recited in the prior art, however, there is no satisfactory possibility of sustained removal of contaminants, not least of those contaminants which occur in connection with time-limited or spontaneous concentration increases in water to be treated or purified. A particular problem in this connection is that large quantities of contaminants occur and must be removed within a relatively short time, a fact which often leads to overloading of prior-art water purification plants, in association with the incidence of unwanted noxiant breakthroughs or the like into the purified water thus provided.

Against this technical background, therefore, an object of the present invention is to provide an efficient method and corresponding plants and apparatuses for treating/purifying (raw) water, especially for obtaining tap water, where the disadvantages of the prior art that have been outlined above are to be at least largely avoided or else at least attenuated.

An object of the present invention is considered, in particular, that of providing a method and associated plants/apparatuses where especially inorganic or organic, especially organic, contaminants, such as micronoxiants or trace pollutants, are to be removed permanently or on a sustained basis from a (raw) water to be treated or purified, and where, in particular, the intention is to ensure improved removal of contaminants which occur in connection with concentration increases, especially limited-time increases or spontaneous increases, such as pesticides, from the water to be treated or purified. In this connection, a further intention is to prevent subsequent release or desorption of hitherto adsorbed pollutants after the concentration increase has run its course or subsided.

In this connection, a further object of the present invention is also seen, in particular, as that of providing an efficient method with which limited-time or spontaneous concentration increases, even of specific contaminants, such as agricultural or industrial-agricultural substances, particularly in the form of pesticides or the like, are attenuated or intercepted. Here, the contaminants causing the concentration increase are to be removed efficiently and permanently from the (raw) water to be treated or purified.

In this regard, according to a further object of the present invention, the aim is also to prevent premature exhaustion of adsorption materials that are used for the preparation/purification, so that in this respect as well prolonged deployment times or service lives of the plants and apparatuses provided in accordance with the invention are ensured.

Furthermore, in accordance with yet a further object of the present invention, the intention is also to provide a highly performing water purification plant with corresponding apparatuses or facilities, especially for implementing the method of the invention, where, while at the same time achieving high purification efficiency with the avoidance of spontaneous breakthroughs on/after incidence of sudden concentration increases on the part of the impurities, the aim is to ensure high cost-efficiency as well, especially as regards the operating time or service life, the consumption of adsorbent for purifying the water undergoing treatment, and the required energy input.

The intention, moreover, is to enable continuous or uninterrupted operation of such a plant, or continuous or uninterrupted implementation of the method.

In particular, yet a further object of the present invention is that of providing a purification or preparation plant, especially for implementing the method of the invention, via which the adsorbent for preparing the water to be treated can be employed efficiently and durably, especially as regards prolonged and uninterrupted operating times and service lives of the adsorption facilities, especially adsorption filter facilities, that are employed in this context.

To achieve the above-outlined object, then, the present invention proposes—according to a first aspect of the present invention—a method for preferably continuous treatment and/or purification of water, especially raw, untreated water, polluted with contaminants, especially organic contaminants, preferably micronoxiants and/or trace substances, preferably for purposes of recovering and/or obtaining treated and/or purified water, especially clean water, preferably tap water and/or service water; further advantageous developments and embodiments of this aspect of the invention are provided.

A further subject of the present invention, moreover—according to a second aspect of the present invention—is a water purification plant, especially for preferably continuous treatment and/or purification of water polluted with contaminants, and a corresponding total water purification plant, as described relating to the water purification plant of the invention and, respectively, to the total water purification plant; advantageous developments and embodiments of the water purification plant of the invention and of the total water purification plant are provided.

Additionally a further subject of the present invention—according to a third aspect of the present invention—are also the inventive uses as described below relating to these uses; advantageous developments and embodiments of the inventive uses according to this aspect of the present invention are also described.

It is self-evident that in the description hereinafter of the present invention, such embodiments, configurations, advantages, examples or the like as are recited below—to avoid unnecessary repetition—in relation only to one single aspect of the invention are of course also valid in relation to the other aspects of the invention, mutatis mutandis, without any need for this to be expressly stated.

It is additionally self-evident that any statements below of values, numbers and ranges are not to be understood as limiting the relevant value, number and range statements; to the person skilled in the art it is self-evident that departures from the specified ranges or statements are possible in a particular case or for a particular application, without departing the realm of the present invention.

It is the case, moreover, that any value or parameter particulars or the like that are stated hereinafter may in principle be ascertained/determined by normalized or standardized or explicitly specified determination methods or else using methods of measurement or determination that are familiar per se to the person skilled in the art in this field. Unless otherwise indicated, the relevant values/parameters are ascertained under standard conditions (i.e., in particular at a temperature of 20° C. and/or under a pressure of 1013.25 hPa or 1.01325 bar).

As for the rest, it should be borne in mind that all below-recited relative or percentage, especially weight-based, quantity particulars are to be selected and/or combined in such a way by the person skilled in the art, within the realm of the present invention, that the resulting sum total—with the inclusion, where appropriate, of further components/ingredients, especially as defined below—is always 100% or 100 wt %. This, however, is self-evident to the person skilled in the art.

For purposes of illustrating the present invention, the description hereinafter of the subject matter of the invention will also employ the reference symbols that are indicated in the figures; the relevant indication of the reference symbols is purely illustrative and does not entail any limitation whatsoever on the subject matter of the invention.

This having been established, the present invention is described in more detail below.

### BRIEF DESCRIPTION OF THE DRAWINGS

FIG. 1A provides a schematic diagram or overview of an inventive method and also of a water purification plant, underlying the method of the invention, according to the invention in one inventive embodiment, whereby the water purification plant comprises a main adsorption facility and a peak load adsorption facility which can be inserted upstream of the main adsorption facility;

FIG. 1B provides a schematic diagram or overview of an inventive method and, respectively, of a further water purification plant, underlying the method of the invention, according to the invention, whereby the peak load adsorption facility comprises corresponding peak load adsorption filter subunits and the main adsorption facility comprises corresponding main adsorption filter subunits;

FIG. 1C provides a schematic diagram or overview of an inventive method and, respectively, of yet a further water purification plant, underlying the method of the invention, according to the invention, whereby the water purification plant comprises a further peak load adsorption facility with associated peak load adsorption filter subunits;

FIG. 2A provides a graph of the specific capacity or the loading amount of the pesticide metaldehyde in relation to the adsorption material or medium used, in the form of a specific spherical activated carbon, for different incoming concentrations of the substance (metaldehyde) to be adsorbed (data points shown as diamonds=constantly low incoming metaldehyde concentration of 0.1 μg/l, and data points shown as squares=constantly high incoming metaldehyde concentrations of 0.5 μg/l with additional concentration peaks of 2 μg/l for six hours) at the breakthrough point or value c>0.01 μg/l (start of breakthrough) and for rising dwell times (empty bed contact time (EBCT)); the x-axis indicates the dwell time (min), and the y-axis indicates the specific capacity in relation to metaldehyde (mg_{metaldehyde}/l_{medium});

FIG. 2B provides a graph corresponding to FIG. 2A, but at the breakthrough point or value c>0.05 μg/l (target value);

FIG. 3 provides a graph of concentration profile of metaldehyde in different untreated water sources A, B, C, as may be processed in relevant water purification plants, with the x-axis showing the time profile and the y-axis indicating the concentration of metaldehyde (μg/l);

FIG. 4 provides a graph for illustrating the presence of unwanted desorption of metaldehyde for a single-stage adsorptive purification operation using different or individual trial columns and/or without deploying an engageable peak load adsorption facility (comparative), where the x-axis indicates the bed volume (BV) and where the y-axis indicates the absolute concentration of metaldehyde (μg/l) at the outflow or outlet of the respective trial column (circular data point representation=first trial column; diamond-shaped data point representation=second trial column; triangular data point representation=concentration of metaldehyde at the entry of the respective column (without concentration increases present or after discharged concentration increases); the lines extending parallel to the x-axis show, from top to bottom, also (i) the mandated metaldehyde limit (using a PCV (permissible concentration value) or a guideline health value (GHV)), (ii) the mandated metaldehyde target value, and (iii) the metaldehyde detection limit, and the lines extending parallel to the y-axis show, from left to right, also (i) the starting point of the implementation or of the presence of concentration increases, (ii) the presence of corresponding concentration rises (following three lines in long-dashed representation), and (iii) the cessation of the implementation or of the presence of concentration increases (following right-hand line in short-dash representation).

### DETAILED DESCRIPTION OF THE INVENTION

A subject of the present invention, therefore—according to a flirt aspect of the present invention—is a method for preferably continuous treatment and/or purification of water A, especially raw, untreated water, polluted with contaminants, especially organic contaminants, preferably micronoxiants and/or trace substances, preferably for purposes of recovering and/or obtaining treated and/or purified water B, especially clean water, preferably tap water and/or service water,

where the contaminants are removed adsorptively from the water A to be treated and/or purified, preferably in the case of concentration increases of the contaminants (also referred to synonymously as concentration rise, peak load concentration or concentration peak) especially those occurring for a limited time and/or spontaneously, in the water A to be treated and/or purified,

where the water A to be treated and/or purified is supplied to a water purification plant 1 (also referred to synonymously as water processing plant) for adsorptive removal of the contaminants, where the water purification plant 1 comprises at least one main adsorption facility 2 (also referred to synonymously as base load adsorption facility) and at least one peak load adsorption facility 3 which is disposed upstream of the main adsorption facility 2 and can be engaged in dependence on a mandated concentration limit, especially on a mandated incoming concentration limit, of the contaminants in the water A to be treated and/or purified,

where the water A to be treated and/or purified is supplied to the main adsorption facility 2 and is treated and/or purified in the main adsorption facility 2, in particular by the contaminants being adsorptively removed at least substantially completely in the main adsorption facility 2, especially in such a way that the concentration of the contaminants is lowered below a mandated outgoing concentration limit, and

where on exceedance of the mandated concentration limit, especially of the mandated incoming concentration limit, of the contaminants in the water A to be treated and/or purified, the peak load adsorption facility 3 is engaged and/or inserted upstream of the main adsorption facility 2, in such a way that the water A to be treated and/or purified is supplied at least partially, preferably completely, first to the peak load adsorption facility 3 and is treated and/or purified in the peak load adsorption facility 3, in particular by the contaminants being adsorptively removed at least partially, preferably by the concentration increase of the contaminants being attenuated and/or evened out (i.e., before the water A to be treated or purified is supplied subsequently to the main adsorption facility 2).

With regard to the term “limited time” or “time-limited” used for the concentration increases of the contaminants, this term relates in particular to the concentration increases in question occurring in a time-limited period or, in particular, temporarily, where the relevant period of time may vary generally within wide ranges. Accordingly, purely by way of example and in a nonlimiting way, the concentration increases in question may have a duration in the range from a few minutes through to several hours, days or months. Moreover, the term “spontaneously” as used likewise for the concentration increases of the contaminants relates in particular to the fact that the concentration increases as such are at least substantially not specifically foreseeable/not predeterminable, especially as regards the frequency and duration of their incidence and also the associated specific concentration/amount of the contaminants.

Merely for clarification, the following may be noted: the terms “upstream” and “downstream” used in the invention pertain in general to the process or operational direction on which the method of the invention and, respectively, the water purification plant 1 of the invention are based (this direction being synonymous with the flow or flow direction of the water to be treated or purified).

A fundamental idea of the present invention, therefore, is as part of the treatment or purification of water A polluted with contaminants, as for example raw, untreated water of the kind used in particular for recovering or obtaining tap water or service water B, in a purposive way—as and when required or dependent on the situation, so to speak—the use of an additional adsorptive filter stage in the form of the peak load adsorption facility 3 for the case as additional adsorptive filter component or filter stage or the engagement of a water purification plant 1 on which the treatment or purification method is based, where a mandated (incoming) concentration limit of the contaminants is exceeded. Here, in the context of the present invention, in the case of a time-limited or spontaneous (incoming) concentration increase of the contaminants in the water A to be treated or purified, and hence in the presence of a concentration peak or peak load concentration, an additional filter stage, in the form of the peak load adsorption facility 3, is employed or engaged in a water purification plant 1 used for water purification, to the effect that the additional adsorption stage in the form of the peak load adsorption facility 3 is inserted upstream or engaged or disposed upstream of the main adsorption facility 2 in question and is charged with the water for purification, entailing a sustained reduction in the amount of impurities arising, in connection with the concentration increase, through the peak load adsorption facility 3, so that the main adsorption facility 2 inserted downstream for this case is only ever charged, so to speak, with a low concentration of the contaminants.

In accordance with the invention, therefore, in dependence on the concentration of contaminants in the water A to be treated or purified, especially in the presence of a time-limited or spontaneous concentration increase, additional adsorption capacities so to speak (namely in the form of the peak load adsorption facility 3 engaged for this case) are provided, and are inserted upstream of the main adsorption facility 2, providing it overall with relief.

The present invention is therefore aimed in particular at the additional commissioning of a preliminary stage in the form of the peak load adsorption facility 3 in response to and/or in dependence on the incidence of a concentration increase of the contaminants, for purposes of reducing or intercepting high entry or incoming concentrations of contaminants as occur on a time-limited basis.

The peak load adsorption facility 3 here is designed in particular such that the concentration increase of the contaminants is attenuated or evened out and that the contaminants present or arising as part of the concentration increase are, so to speak, at least partly intercepted, thus lowering the concentration of contaminants in the peak load adsorption facility 3 below the mandated concentration limit, especially incoming concentration limit. Accordingly, in the method of the invention, in the event or in dependence on the incidence of a concentration increase, the main adsorption facility 2, which is disposed downstream of the peak load adsorption facility 3, is relieved in that the water entering there and pretreated in the peak load adsorption facility 3 has an evened-out or reduced concentration of contaminants and/or has already been at least partly freed of the contaminants associated with the concentration increase. Accordingly, the downstream main adsorption facility 2 is able to effect a further and sustained removal of the remaining contaminants, without overloading or premature exhaustion of the main adsorption facility 2.

On the basis of the design approach of the invention, therefore, the targeted engagement of the peak load adsorption facility 3 on exceedance of the mandated concentration limit, especially incoming concentration limit, with the associated relief of the main adsorption facility 2, which is inserted downstream for this case, means that the risk of breakthroughs of contaminants, for the critical event of the incidence of concentration increases of the contaminants, is sustainedly reduced or avoided.

Through the inventive design approach of the concentration-dependent or limit-dependent engagement for the peak load adsorption facility 3 for the purposive interception/attenuation of time-limited/spontaneous concentration increases of the contaminants, the present invention provides a tailored method for optimized treatment/processing of (raw, untreated) water, especially to obtain tap water or service water, said method enabling a reliable, tailored purification of the relevant water, adapted to the particular load situation, in conjunction with an improvement in process economics, said method also minimizing the risk of noxiant breakthroughs, as indicated above, through the targeted interception/attenuation of concentration increases of the relevant contaminants.

In this connection, the invention is geared, so to speak, to two operational states, whereby under normal contaminant pollution of the water to be treated or purified, so to speak, the procedure is single-stage with sole operation of the main adsorption facility 2, whereas, at correspondingly incident concentration increases with the exceedance of the (incoming) limit, the procedure, so to speak, is two-stage, with additional operation/engagement/upstream insertion of the peak load adsorption facility 3.

The peak load adsorption facility 3 on the one hand and the main adsorption facility 2 on the other supplement one another in functional terms especially in the sense that on the one hand the concentration increase is attenuated or reduced in the peak load adsorption facility 3 (in association with relief of the main adsorption facility 2) and that on the other hand the main adsorption facility 2 is easily able to intercept concentrations of contaminants which, while present, are reduced in the water A to be treated or purified after passage through the peak load adsorption facility 3.

On the basis of the design approach according to the invention, moreover, the service life or deployment time or operating duration of the inventively employed water purification plant 1 is significantly extended, since first the main adsorption facility 2 is relieved by the concentration-dependent engagement of the peak load adsorption facility 3 and since secondly the peak load adsorption facility 3 as such is engaged only under certain conditions, namely in the presence of the concentration increases in question, with the consequence that its service life or deployment time or operating duration is also increased.

In this context, the service life is also increased insofar as the respective components, in the form of the peak load adsorption facility 3 and of the main adsorption facility 2, can be utilized more efficiently, especially in relation to maximum utilization of the relevant adsorption capacity or filter capacity. On the one hand, then, the peak load adsorption facility 3 can be given a greater loading of contaminants (i.e., even then (virtually) up to its capacity limit) for the reason that, even on any exceedance of the capacity limit, the main adsorption facility 2, which is inserted downstream when concentration increases are present, is readily able to intercept the hitherto unabsorbed contaminants. Moreover, the main adsorption facility 2 itself can be given a higher loading of contaminants (i.e., again (virtually) up to its capacity limit) because, through the evening-out of the noxiant concentration by the peak load adsorption facility 3 that is inserted upstream when concentration increases are present, the downstream main adsorption facility 3 is not unduly loaded with contaminants, since these contaminants have already been intercepted beforehand. As a result, the adsorption material in the respective adsorption facilities 2, 3 can be utilized more efficiently overall.

Furthermore, the dwell time of the water to be treated or purified, especially in the main adsorption facility 2, can be reduced by reason in particular of the reduced preliminary load with the contaminants in question, this also being beneficial overall to the implementation of the method.

A further central advantage of the present invention is also that, because of the inventive design approach with the concentration-dependent upstream insertion of the peak load adsorption stage 3, it is possible to prevent the danger of unwanted desorption, especially with subsequent breakthrough into the resultant tap water or service water, of contaminants previously adsorbed, after exceedance of the concentration increase or in the event of a falling noxiant concentration in the water A to be treated or purified.

The reason is that, as a result of the purposive deployment of the peak load adsorption facility 3 in the event of high (peak load) concentrations of the contaminants, the danger of desorption in relation to the inventively used water purification plant 1 is reduced overall, because the peak load adsorption facility 3 is operated or charged only with/at high entry concentrations or incoming concentrations or high concentration increases of the contaminants, whereas the main adsorption facility 2 is consistently operated or charged only with correspondingly reduced or low and even or evened-out (entry or incoming) concentrations, with the consequence that both components are operated each with relatively even concentrations of contaminants.

The inventive design approach also takes account of the surprising realization by the applicant that in fact low entry or incoming concentrations of contaminants lead to low (adsorption) capacities of the adsorption materials used, especially activated carbon, whereas high entry concentrations in contaminants lead to high (adsorption) capacities. In this respect as well, high capacities are achieved, leading to a further boost in efficiency, for the peak load adsorption facility 3, which is engaged only in the event of high noxiant concentrations or concentration increases of the contaminants.

Another advantage in the context of the present invention is the fact that the peak load adsorption facility 3 need only be designed to reduce the concentration of contaminants initially especially below the mandated concentration limit or incoming concentration limit of the water A to be treated or purified, and so a further reduction in the concentration, especially to the mandated outgoing concentration limit, of the water B treated or purified overall is unnecessary to the extent that the concentration is further reduced by the downstream main adsorption facility 2. Consequently, overall, using the inventively employed water purification plant 1, passage through said plant results in the attainment of a mandated (tap water) limit of the contaminants.

As a consequence of this as well, the peak load adsorption facility 3 overall can be given a smaller size and/or can have a lower filter volume or lower quantity of adsorption material in comparison to the main adsorption facility 2, which is also an advantage.

Another advantage of the present invention is that the inventively used water purification plant 1 with the relevant main adsorption facility 2 and the peak load adsorption facility 3 insertable upstream of the main adsorption facility 2 can be integrated into existing purification plants, or existing purification plants can be retrofitted with the water purification plant 1, in association with implementation of the method according to the invention. In this context, the water purification plant 1 or the inventive method can be employed in particular as part of a purification/treatment downstream of an existing plant, where in particular the main adsorption facility 2 can operate as a final treatment or purification stage, especially with optional upstream insertion or arrangement of peak load adsorption facility 3, which is operated or charged in the event of exceedance of a concentration limit of contaminants, especially of an incoming concentration limit, in addition to the main adsorption facility 2.

Moreover, the peak load adsorption facility 3 on the one hand and also the main adsorption facility 2 on the other can overall be reduced in size, especially with regard to their filter volume or adsorption capacity, with an increase in the cost-effectiveness and overall simplification of management.

Generally speaking, the peak load adsorption facility 3 can be designed/operated in such a way that on exceedance of the mandated concentration limit, especially incoming concentration limit, the concentration of the contaminants at the outlet of the peak load adsorption facility 3 is lowered below the mandated concentration limit, especially the mandated incoming concentration limit. Moreover, the main adsorption facility 2 can be designed/operated in particular in such a way that the concentration of contaminants in the water A to be treated or purified and/or in the resultant tap water and/or service water B, at the exit or at the outlet of the main adsorption facility 2, is lowered below the mandated outgoing concentration limit.

Through the purposive procedure of attenuation or evening-out of the time-limited or spontaneous concentration increases of the contaminants, moreover, it is possible to more precisely determine or predict the service life of the relevant purification plant 1 or of a corresponding total plant.

In summary, then, the situation with the method of the invention is in particular such that the peak load adsorption facility 3 is loaded or charged in particular only with or at high entry concentrations of the contaminants (noxiant concentration above the mandated concentration limit, especially incoming concentration limit), of the kind present with a time-limited or spontaneous concentration increase, the associated loading capacities and removal rates being high. The purposive engagement of the peak load adsorption facility 3 in the presence or incidence of the concentration increase also entails a reduced risk of the incidence of unwanted desorption of the contaminants. Moreover, the peak load adsorption facility 3 can be employed up to the point of exhaustion or saturation with the adsorption materials therein. In accordance with the invention, so to speak, the peak load adsorption facility 3 is deliberately employed in response to the presence of a concentration increase of the contaminants, and is inserted upstream of the main adsorption facility 2, for relief.

Another result, in particular, of the design approach according to the invention is that in the event of the presence of a concentration increase, the main adsorption facility 2 downstream of the peak load adsorption facility 3 is loaded or charged with consistently small or low incoming concentrations of the contaminants, which in particular lie below the mandated concentration value, especially incoming concentration value. As a result, the service life of the main adsorption facility 2 is prolonged, and its service life is also precisely predictable, moreover. For the main adsorption facility 2 and hence for the water purification plant 1 overall, as well, the risk of desorption of contaminants is reduced, especially since in operation with the upstream insertion of the peak load adsorption facility 3, there is no sudden concentration drop in the contaminants in the main adsorption facility 2 either. Overall, therefore, the design approach of the invention also leads to a prolongation of the service life of the main adsorption facility 2 as well and hence, equally, of the water purification plant 1 overall.

Below, the method of the invention is further described with the relevant embodiments of the invention:

The water A to be treated or processed within the method of the invention is, as indicated above, more particularly raw, untreated water, preferably raw water pretreated in accordance with tap water. In particular, the water A for treatment or purification in accordance with the invention, as especially raw water, preferably raw water pretreated in accordance with tap water, may without restriction be selected from groundwater, bank filtrate, and surface water, especially from running water bodies and/or lakes and/or dams. The water in question may have already passed through purification stages that are necessary and/or relevant particularly for the acquisition of tap water.

A particular possibility in accordance with the invention is that the peak load adsorption facility 3 is engaged and/or is inserted upstream of the main adsorption facility 2 in such a way that the concentration of contaminants in the water A to be treated and/or purified is lowered downstream of the peak load adsorption facility 3 and/or at the outlet of the peak load adsorption facility 3, based on the process or operational direction, below the mandated concentration limit, especially the mandated incoming concentration limit.

It is also a possibility in accordance with the invention that the peak load adsorption facility 3 is engaged and/or inserted upstream of the main adsorption facility 2 in such a way that—hence also in the case of the course of a concentration increase or peak load concentration—the concentration of contaminants in the treated and/or purified water B and/or downstream of the main adsorption facility 2 and/or at the outlet of the main adsorption facility 2, based on the process and/or operational direction, is lowered below the mandated outgoing concentration limit.

As indicated above, the targeted engagement or upstream insertion of the peak load adsorption facility 3, which is carried out on incidence or detection of a time-limited or spontaneous concentration increase of the contaminants, achieves a sustained reduction in the concentration-increase-associated contaminant loading of the water to be treated or purified, so that after passage through the engaged peak load adsorption facility 3, the concentration of contaminants is lowered in particular beneath the mandated concentration limit, especially the mandated incoming concentration limit, with the design approach of the invention also ensuring that the main adsorption facility 2 disposed downstream of the peak load adsorption facility 3 for this case further reduces the noxiant load in the treated or purified water B, and so, after passage through the main adsorption facility 2, the concentration of contaminants overall is lowered beneath the mandated outgoing limit, and hence overall an effective and reliable purification of the relevant water is ensured even on incidence of the concentration increase in question.

With regard in this context on the one hand to the mandated concentration limit, especially incoming concentration limit (i.e., in particular, the concentration value at the inlet or entry of the water processing plant 1 or peak load adsorption facility 3) and on the other hand to the mandated outgoing concentration limit (i.e., in particular, the concentration value of the contaminants at the outlet or exit of the water processing plant 1 or the main adsorption facility 2), the situation in the context of the method of the invention may in particular be such that the outgoing concentration limit selected is smaller in comparison to the mandated concentration limit, especially incoming concentration limit. In particular, the outgoing concentration limit may be mandated in accordance with relevant mandates or requirements for tap water or raw water. The outgoing concentration limit may be mandated, for example, employing what are known as guideline health values (GHVs), especially in dependence on the particular contaminants to be removed. The mandated outgoing limit may in particular also be determined by taking account of legally prescribed limit values and also what are called target values. For example, the outgoing limit in relation to pesticides, especially metaldehyde, may be mandated in accordance with the legally permitted limit (<0.1 μg/l) or the relevant target value (<0.05 μg/l). On this basis, a flexible or tailored management in relation to the contaminants to be removed and also to the desired or required quality of the treated or purified water B is possible overall. Alternatively the mandated concentration limit, especially incoming concentration limit, may be selected or mandated with reference to the relevant concentration increase and also in dependence on the contaminants to be removed. For this purpose, reference may also be made to statements below.

In accordance with the invention it has proved particularly advantageous if the main adsorption facility 2 comprises at least one particulate adsorption material, especially a particulate activated carbon, preferably a granular activated carbon, more preferably a spherical activated carbon. A particular possibility is that the main adsorption facility 2 comprises a fixed bed filter and/or a fixed bed based on at least one particulate adsorption material, especially based on particulate activated carbon, preferably based on granular activated carbon, more preferably based on spherical activated carbon, especially in a loose heap of the particulate adsorption material.

In accordance with the invention it is also an advantage if the peak load adsorption facility 3 comprises at least one particulate adsorption material, especially a particulate activated carbon, preferably a granular activated carbon, more preferably a spherical activated carbon.

A particular possibility is that the peak load adsorption facility 3 comprises a fixed bed filter and/or a fixed bed based on at least one particulate adsorption material, especially based on particulate activated carbon, preferably based on granular activated carbon, more preferably based on spherical activated carbon, especially in a loose heap of the particulate adsorption material.

Through the use of the aforesaid adsorption materials, particularly good purification/adsorption results are achieved in terms of the contaminants to be removed, and also the flow behavior of the water A, to be treated or purified, into the corresponding facilities 2, 3 is further improved. In accordance with the invention it is especially the case in this context that the water A to be treated or purified is guided or passed in each case through a heap, especially a loose heap, of the aforesaid adsorption materials when implementing the method of the invention.

With further regard to the peak load adsorption facility 3 used within the method of the invention, it is subject in particular to the following statements: A particular possibility in accordance with the invention is that the peak load adsorption facility 3 has a lower fixed bed filter volume V_{PLA}, especially a lower volume of the heap, of the particulate adsorption material, especially of the particulate activated carbon, preferably of the granular activated carbon, more preferably of the spherical activated carbon, and/or a lower amount of the particulate adsorption material, especially of the particulate activated carbon, preferably of the granular activated carbon, more preferably of the spherical activated carbon, than the main adsorption facility 2.
A further possibility is that the peak load adsorption facility 3 has a fixed bed filter volume V_{PLA}, especially a volume of the heap, of the particulate adsorption material, especially of the particulate activated carbon, preferably of the granular activated carbon, more preferably of the spherical activated carbon, of at least 0.01 m³, especially at least 0.1 m³, preferably at least 0.5 m³, more preferably at least 1 m³, very preferably at least 5 m³, especially preferably at least 10 m³, with further preference at least m³.
Another possibility is that the peak load adsorption facility 3 has a fixed bed filter volume V_{PLA}, especially a volume of the heap, of the particulate adsorption material, especially of the particulate activated carbon, preferably of the granular activated carbon, more preferably of the spherical activated carbon, in a range from 0.01 m³ to 750 m³, especially in a range from 0.1 m³ to 600 m³, preferably in a range from 0.5 m³ to 500 m³, more preferably in a range from 1 m³ to 300 m³, very preferably in a range from 5 m³ to 200 m³, especially preferably in a range from 10 m³ to 100 m³, with further preference in a range from 15 m³ to 150 m³.

With regard, moreover, to the main adsorption facility 2 used in the method of the invention, guidance in this regard may be obtained in particular from the following statements:
Hence it is possible in accordance with the invention that the main adsorption facility 2 has a fixed bed filter volume V_{MA}, especially a volume of the heap, of the particulate adsorption material, especially of the particulate activated carbon, preferably of the granular activated carbon, more preferably of the spherical activated carbon, of at least 1 m³, especially at least 5 m³, preferably at least 10 m³, more preferably at least 15 m³, very preferably at least 20 m³.
A particular possibility is that the main adsorption facility 2 has a fixed bed filter volume V_{MA}, especially a volume of the heap, of the particulate adsorption material, especially of the particulate activated carbon, preferably of the granular activated carbon, more preferably of the spherical activated carbon, in a range from 1 m³ to 1500 m³, especially in a range from 5 m³ to 1000 m³, preferably in a range from 10 m³ to 800 m³, more preferably in a range from 15 m³ to 600 m³, very preferably in a range from 20 m³ to 400 m³.

In terms of efficient adsorptive removal of the relevant contaminants, and especially in relation to the removal of contaminants forming the basis of a time-limited or spontaneous concentration increase, it may in particular be the case that the ratio of the fixed bed filter volume V_{MA}, especially of the volume of the heap, of the particulate adsorption material, especially of the particulate activated carbon, preferably of the granular activated carbon, more preferably of the spherical activated carbon, of the main adsorption facility 2, on the one hand, to the fixed bed filter volume V_{PLA}, preferably volume of the heap, of the particulate adsorption material, especially of the particulate activated carbon, preferably of the granular activated carbon, more preferably of the spherical activated carbon, of the peak load adsorption facility 3, on the other hand, is at least 1:1, especially at least 1.05:1, preferably at least 1.1:1, more preferably at least 1.2:1, very preferably at least 1.4:1, especially preferably at least 1.6:1.

A particular possibility is that the ratio of the fixed bed filter volume V_{MA}, especially of the volume of the heap, of the particulate adsorption material, especially of the particulate activated carbon, preferably of the granular activated carbon, more preferably of the spherical activated carbon, of the main adsorption facility 2, on the one hand, to the fixed bed filter volume V_{PLA}, preferably volume of the heap, of the particulate adsorption material, especially of the particulate activated carbon, preferably of the granular activated carbon, more preferably of the spherical activated carbon, of the peak load adsorption facility 3, on the other hand, is in a range from 1.05:1 to 500:1, especially in a range from 1.05:1 to 100:1, preferably in a range from 1.1:1 to 50:1, more preferably in a range from 1.2:1 to 30:1, very preferably in a range from 1.4:1 to 20:1, especially preferably in a range from 1.6:1 to 10:1, with further preference in a range from 1.8:1 to 5:1.

In accordance with the invention it is also possible that the peak load adsorption facility 3 has a lower amount, especially weight amount, of particulate adsorption material, especially particulate activated carbon, preferably granular activated carbon, more preferably spherical activated carbon, than the main adsorption facility 2 or that the main adsorption facility 2 has a larger amount, especially weight amount, of particulate adsorption material, especially particulate activated carbon, preferably granular activated carbon, more preferably spherical activated carbon, than the peak load adsorption facility 3.

In this connection it is possible that the ratio of the amount, especially weight amount, of particulate adsorption material, especially particulate activated carbon, preferably granular activated carbon, more preferably spherical activated carbon, of the main adsorption facility 2, on the one hand, to the amount, especially weight amount, of particulate adsorption material, especially particulate activated carbon, preferably granular activated carbon, more preferably spherical activated carbon, of the peak load adsorption facility 3, on the other hand, is at least 1:1, especially at least 1.05:1, preferably at least 1.1:1, more preferably at least 1.2:1, very preferably at least 1.4:1, especially preferably at least 1.6:1.

A particular possibility is that the ratio of the amount, especially weight amount, of particulate adsorption material, especially particulate activated carbon, preferably granular activated carbon, more preferably spherical activated carbon, of the main adsorption facility 2, on the one hand, to the amount, especially weight amount, of particulate adsorption material, especially particulate activated carbon, preferably granular activated carbon, more preferably spherical activated carbon, of the peak load adsorption facility 3, on the other hand, is in a range from 1.05:1 to 100:1, especially in a range from 1.1:1 to 50:1, preferably in a range from 1.2:1 to 30:1, more preferably in a range from 1.4:1 to 20:1, very preferably in a range from 1.6:1 to 10:1, especially preferably in a range from 1.8:1 to 5:1.

In general, moreover, the peak load adsorption facility 3 may have a lower total filter capacity, especially total adsorption capacity, than the main adsorption facility 2. In other words, then, the main adsorption facility 2 may have a larger total filter capacity, especially total adsorption capacity, than the peak load adsorption facility 3.

In this regard it is possible that the ratio of the total filter capacity, especially total adsorption capacity, of the main adsorption facility 2, on the one hand, to the total filter capacity, especially total adsorption capacity, of the peak load adsorption facility 3, on the other hand, is at least 1:1, especially at least 1.1:1, preferably at least 1.2:1, more preferably at least 1.3:1, very preferably at least 1.5:1.

In this connection it is possible that the ratio of the total filter capacity, especially total adsorption capacity, of the main adsorption facility 2, on the one hand, to the total filter capacity, especially total adsorption capacity, of the peak load adsorption facility 3, on the other hand, is in a range from 1.1:1 to 150:1, especially in a range from 1.2:1 to 100:1, preferably in a range from 1.3:1 to 50:1, more preferably in a range from 1.5:1 to 25:1.

Consequently the inventively employed peak load adsorption facility 3 may be smaller in dimensions, overall, than the main adsorption facility 2, this being derived in particular from the surprising realization by the applicant that high incoming concentrations—of the kind present on exceedance of the mandated concentration limit, especially the mandated incoming concentration limit, for the peak load adsorption facility 3 engaged to the main adsorption facility 2—lead to high loading capacities on the part of the adsorption material, and so on this basis correspondingly high removal rates can be realized with relatively small sizing of the peak load adsorption facility 3.

In the method of the invention, moreover, it may be the case that the dwell time and/or contact time in the peak load adsorption facility 3 of the water A to be treated and/or purified is less than in the main adsorption facility 2 and/or that the dwell time and/or contact time in the peak load adsorption facility 3 of the water A to be treated and/or purified is set to a lower value than in the main adsorption facility 2. In particular it may be the case that the dwell time and/or contact time in the main adsorption facility 2 of the water A to be treated and/or purified is greater than in the peak load adsorption facility 3, or that the dwell time and/or contact time in the main adsorption facility 2 of the water A to be treated and/or purified is set at a greater value than in the peak load adsorption facility 3.

In this regard it is possible that the dwell time and/or contact time in the peak load adsorption facility 3 of the water A to be treated and/or purified is in a range from 1 s to 420 min, especially 5 s to 240 min, preferably 20 s to 120 min, more preferably 1 min to 90 min, very preferably 2 min to 45 min, and/or is set to the aforesaid values.

In this connection it is possible that the dwell time and/or contact time in the main adsorption facility 2 of the water A to be treated and/or purified is in a range from 10 s to 600 min, especially in a range 30 s to 300 min, preferably in a range from 1 min to 180 min, more preferably in a range from 2 min to 120 min, very preferably in a range from 4 min to 90 min, and/or is set to the aforesaid values.

A particular possibility is that the ratio of the dwell time and/or contact time in the main adsorption facility 2 of the water A to be treated and/or purified to the dwell time and/or contact time in the peak load adsorption facility 3 of the water A to be treated and/or purified is at least 1:1, especially at least 1.05:1, preferably at least 1.1:1, more preferably at least 1.2:1, very preferably at least 1.4:1, especially preferably at least 1.6:1, and/or is set to the aforesaid values.

A particular possibility is that the ratio of the dwell time and/or contact time in the main adsorption facility 2 of the water A to be treated and/or purified to the dwell time and/or contact time in the peak load adsorption facility 3 of the water A to be treated and/or purified is in a range from 1:1 to 100:1, especially in a range from 1.05:1 to 50:1, preferably in a range from 1.1:1 to 30:1, more preferably in a range from 1.2:1 to 10:1, very preferably in a range from 1.4:1 to 5:1, especially preferably in a range from 1.6:1 to 2:1, and/or is set to the aforesaid values.

The aforementioned measures take further account in particular of the function of the peak load adsorption facility 3 in attenuating or evening-out the concentration increase of the contaminants. The aforesaid measures also further improve purification of the relevant water overall, particularly also in relation to the acquisition of a mandated outgoing concentration limit of the contaminants.

In accordance with the invention, moreover, preferred or the below-recited operating times/service lives may be achieved:

It is possible in this context that the water purification plant 1 on which the method of the invention is based has a service life and/or a bed volume (BV) of at least 1000 BV, especially at least 5000 BV, preferably at least 10 000 BV, more preferably at least 15 000 BV, very preferably at least 20 000 BV, calculated as the quotient of the volume of the treated and/or purified water (V_{H2O}), on the one hand, to the sum total of the fixed bed filter volume (V_{PLA}), especially of the volume of the heap, of the particulate adsorption material of the peak load adsorption facility 3 and of the fixed bed filter volume (V_{MA}), especially of the volume of the heap, of the particulate adsorption material of the main adsorption facility 2, on the other hand, of [BV=V_{H2O[m}_{³}_{]}/(V_{PLA[m}_{³}_{]}+V_{MA[m}_{³}_{]})].

It is possible in this context that the water purification plant 1 has a service life and/or a bed volume (BV) in a range from 1000 BV to 500 000 BV, especially in a range from 5000 BV to 200 000 BV, preferably in a range from 10 000 BV to 100 000 BV, more preferably in a range from 15 000 BV to 50 000 BV, very preferably in a range from 20 000 BV to 40 000 BV, calculated as the quotient of the volume of the treated and/or purified water (V_{H2O}), on the one hand, to the sum total of the fixed bed filter volume (V_{PLA}), especially of the volume of the heap, of the particulate adsorption material of the peak load adsorption facility 3 and of the fixed bed filter volume (V_{MA}), especially of the volume of the heap, of the particulate adsorption material of the main adsorption facility 2, on the other hand, of [BV=V_{H2O[m}_{³}_{]}/(V_{PLA[m}_{³}_{]}+V_{MA[m}_{³}_{]})].

The fixed bed filter volume V_{PLA} of the peak load adsorption facility 3 and the fixed bed filter volume V_{MA} of the main adsorption facility 2 here relate, as indicated above, in particular to the respective fixed bed filter volume, especially the volume of the heap, of the respective particulate adsorption material, especially of the particulate activated carbon, preferably of the granular activated carbon, more preferably of the spherical activated carbon.

The design approach of the invention results, in comparison to prior-art systems, in a significant prolongation of the service life or the usage times or operating durations of the relevant water purification plant 1, this entailing high cost-effectiveness of the design approach of the invention. In particular the respective adsorption materials as indicated above can be utilized optimally in terms of their adsorption capacity, since even on high loading of the adsorbents with the contaminants, the risk of breakthroughs is significantly reduced and at the same time the mandated outgoing concentration limits are achieved.

With further regard to the method of the invention, it is preferable that the water purification plant 1 is operated at least substantially continuously and/or that the water A to be treated and/or purified is guided and/or passed at least substantially continuously through the water purification plant 1, especially the peak load adsorption facility 3 and/or the main adsorption facility 2. By this means it is possible overall to achieve high throughputs with outstanding purification efficiency.

In this context it is the case in accordance with the invention in particular that the treatment and/or purification of the water A polluted with contaminants is carried out at least substantially continuously.

In particular, the water A to be treated and/or purified is supplied at least substantially continuously to the water purification plant 1. In particular, moreover, the treated and/or purified water B, especially the tap water and/or service water, is taken off at least substantially continuously from the water purification plant 1. In the water purification plant 1 of the invention, accordingly, the result in particular is a continuous flow, especially volume flow, or flux of the water used.

Against this background as well, the regime of the invention can be tailored such that the volume flow or throughput of the water A to be treated or purified or of the treated or purified water B (in which case the corresponding volume flows are of equal size at least substantially, owing to the at least substantially loss-free operation of the plant) vary within wide ranges, and so for this reason as well the method of the invention can be individually oriented: A particular possibility is that the water purification plant 1 is operated with a volume flow rate, especially volume flow rate of water A to be treated and/or purified and/or volume flow rate of treated and/or purified water B, in a range from 1 m³/h to 50 000 m³/h, especially in a range from 5 m³/h to 30 000 m³/h, preferably in a range from 10 m³/h to 10 000 m³/h, more preferably in a range from 50 m³/h to 5000 m³/h, very preferably in a range from 100 m³/h to 3000 m³/h.

In the method of the invention, in particular, the water A to be treated and/or purified is passed and/or guided through and/or into the peak load adsorption facility 3 (and specifically for the case of the engagement of the peak load adsorption facility 3 or upstream insertion before the main adsorption facility 2 on exceedance of the mandated concentration limit, especially incoming concentration limit).

It is also the case in accordance with the invention in particular that the water A to be treated and/or purified is passed and/or guided through and/or into the main adsorption facility 2 and specifically both for the case of the engagement of the peak load adsorption facility 3 (two-stage adsorption operation) and for the case of the sole operation of the main adsorption facility 2 on shortfall or on nonattainment of the mandated adsorption limit, especially incoming concentration limit (one-stage adsorption operation).

Accordingly, in accordance with the invention, in other words, it is in particular the case that on exceedance of the mandated concentration limit, especially incoming concentration limit, the water A to be treated and/or purified is passed and/or guided at least partially, preferably completely, first through and/or into the peak load adsorption facility 3 and passed and/or guided subsequently through and/or into the main adsorption facility 2.

In particular, in other words, on exceedance of the mandated concentration limit, especially incoming concentration limit, the water A to be treated and/or purified is passed and/or guided at least partially, preferably completely, first through and/or into the peak load adsorption facility 3.

In accordance with the invention, therefore, the procedure in particular is such that on exceedance of the mandated concentration limit, especially incoming concentration limit, the water A to be treated and/or purified is supplied at least partially, preferably completely, first to the peak load adsorption facility 3 and treated and/or purified in the peak load adsorption facility 3 and subsequently is supplied to the main adsorption facility 2 and treated and/or purified in the main adsorption facility 2.

Conversely, on shortfall or nonattainment of the mandated concentration value, especially incoming concentration value, it is the case in particular that the water A for treatment or purification is treated/purified directly in the main adsorption facility 2, in particular with circumvention or omission of the peak load adsorption facility 3.

According to a first inventively preferred embodiment, a possible procedure in particular is that on exceedance of the mandated concentration limit, especially incoming concentration limit, the total flow of the water A to be treated and/or purified, and/or the water A to be treated and/or purified, is supplied first to the peak load adsorption facility 3 and the water A to be treated and/or purified is treated and/or purified in the peak load adsorption facility 3 and is subsequently supplied to the main adsorption facility 2 and is treated and/or purified in the main adsorption facility 2. In an inventively preferred way, therefore, on engagement or upstream insertion of the peak load adsorption facility 3, the entire volume flow of the water B to be treated or purified is passed via or through the peak load adsorption facility 3, and so on this basis the maximum efficiency of removal/reduction of the increased contaminant property associated with the concentration increase is ensured.

According to a further inventive embodiment, moreover, it is also possible that on exceedance of the mandated concentration limit, especially incoming concentration limit, the total flow of the water A to be treated and/or purified is divided in such a way that a first divisional stream of the water A to be treated and/or purified is first supplied to the peak load adsorption facility 3 and is treated and/or purified in the peak load adsorption facility 3 and is subsequently supplied to the main adsorption facility 2 and is treated and/or purified in the main adsorption facility 2, and that a second divisional stream of the water A to be treated and/or purified is supplied to the main adsorption facility 2 directly and/or with circumvention and/or omission of the peak load adsorption facility 3 and treated and/or purified in the main adsorption facility 2.

In this regard it is possible that the first divisional stream and the second divisional stream are merged and/or united upstream of the main adsorption facility 2. In particular, it is possible that the first divisional stream is supplied to the second divisional stream upstream of the main adsorption facility 2. For this case, therefore, the main adsorption facility 2 is operated or charged with the total stream of the divisional streams united beforehand.

In principle, however, another possibility is that the first divisional stream and the second divisional stream are merged and/or united downstream of the main adsorption facility 2.

Accordingly, it is possible that the first divisional stream is supplied to the second divisional stream downstream of the main adsorption facility 2.

With regard to the aforesaid divisional streams overall, it is possible that the fraction, especially volume flow fraction, of the second divisional stream as a proportion of the total stream is at least 50%, especially at least 60%, preferably at least 70%, more preferably at least 80%, very preferably at least 90%, especially preferably at least 95%, based on the total stream.

In the method of the invention it is the case in particular that on shortfall and/or presence and/or nonattainment of the mandated concentration limit, especially incoming concentration limit, the water A to be treated and/or purified is supplied at least substantially completely to the main adsorption facility 2 directly and/or with circumvention and/or omission of the peak load adsorption facility 3 and treated and/or purified in the main adsorption facility 2, as indicated above.

In other words, the situation according to the invention is particularly that, on previously engaged peak load adsorption facility 3 and on shortfall of the limit in question, the peak load adsorption facility 3 is disengaged again, so that the total stream of water A for treatment/purification is now guided through the main adsorption facility 2, with the peak load adsorption facility 3 being circumvented. In the invention, therefore, the reliance is on a temporary or time-limited deployment of the peak load adsorption facility 3, which indeed, authoritatively, in the presence of a concentration increase of the contaminants or on exceedance of the concentration limit in question, especially incoming concentration limit, is put into operation and inserted upstream of the main adsorption facility 2. As a result of the merely temporary or time-limited deployment of the peak load adsorption facility 3, which is dependent, so to speak, on the presence of the concentration increase, the adsorption capacity or filter capacity of said facility 3 is therefore not used unnecessarily. Moreover, by virtue of this inventive design approach, as indicated above, the risk of unwanted desorption of the contaminants from the peak load adsorption facility 3 is avoided as well, since the peak load adsorption facility 3 is operated/charged only at correspondingly high concentrations of contaminants, and so in the peak load adsorption facility 3 there is no desorption-inducing concentration drop in the water A to be treated or purified.

A further possibility in accordance with the invention is that the water purification plant 1, additionally to the main adsorption facility 2 and/or peak load adsorption facility 3, comprises at least one further processing and/or treatment facility, especially a plurality of further preparation and/or treatment facilities. In this regard a possibility is that the further processing and/or treatment facility is configured and/or present in the form of a mechanically, physically, chemically and/or biologically based and/or functioning processing and/or treatment facility. In particular the further preparation or treatment facilities are inserted upstream or disposed upstream of the adsorption facility 2 and of the peak load adsorption facility 3, respectively.

In accordance with the invention, with regard to the measure whereby the water purification plant 1, additionally to the main adsorption facility 2 and/or additionally to the peak load adsorption facility 3, comprises at least one further processing and/or treatment facility, it may in particular be the case that the further processing and/or treatment facility comprises or consists of at least one—especially mechanical—preliminary and/or coarse filter facility and/or at least one flocculation and/or sedimentation facility and/or at least one—especially mechanical—fine filter facility and/or at least one basic adsorption facility.

A particular possibility in one preferred embodiment is that the further processing and/or treatment facility comprises

(i) at least one—especially mechanical—preliminary and/or coarse filter facility,

(ii) at least one flocculation and/or sedimentation facility,

(iii) at least one—especially mechanical—fine filter facility, and

(iv) optionally at least one basic adsorption facility,

especially in the above order (i) to (iv), based on the process and/or operational direction.

In this context, therefore, it is possible that the flocculation and/or sedimentation apparatus is arranged downstream of the preliminary and/or coarse filter apparatus. It may equally be the case that the fine filter apparatus is arranged downstream of the preliminary and/or coarse filter apparatus and/or of the flocculation and/or sedimentation apparatus. Lastly, it is also possible in accordance with the invention that the basic adsorption apparatus is arranged downstream of the preliminary and/or coarse filter apparatus and/or of the flocculation and/or sedimentation apparatus and/or of the fine filter apparatus.

Through the preliminary or coarse filter apparatus it is possible in particular to carry out mechanical prepurification or purification of the water A to be treated or purified, where, for example, relatively large and undissolved constituents in the water A or the like to be treated or purified can be removed. Using the flocculation/sedimentation apparatus, the water A to be treated or purified can in particular be treated chemically, using flocculants or the like, for example, or treated further mechanically, in which case, in particular, the previously flocculated constituents can be removed in the form of a sediment. Using the optional mechanical fine filter facility, it is possible in particular to remove relatively large or coarse undissolved constituents in the water or the like for treatment or purification.

Lastly, with the optional use of the basic adsorption facility, it is possible to carry out (basic) adsorption of contaminants, especially upstream of the water purification plant 1, especially using or deploying standard adsorption materials, such as, for example, activated carbon or the like based on charcoal, bituminous coal, lignite coal, pitch, olive kernels and/or coconut shells.

In accordance with the invention, it is possible in particular that the inventively employed water purification plant 1 comprises exactly one preparation or treatment facility, which is inserted or arranged upstream of the peak load adsorption facility 3 and of the main adsorption facility 2, where the preparation or treatment facility comprises a preliminary or coarse filter facility, a flocculation and/or sedimentation facility, a mechanical filter facility, and, optionally, a basic adsorption facility, where the aforesaid apparatuses are arranged in the above-stated order, based on the process or operational direction.

Accordingly, the inventively employed water purification plant 1 may be designed as a functional total plant for providing treated or purified water B, especially tap water or service water, and through specific selection and refinement or arrangement of the apparatuses in question, the inventively used water purification plant 1 can be designed individually or tailored in line with the particular intended application or use.

In general it is possible that the further processing and/or treatment facility, especially the plurality of further preparation and/or treatment facilities, is arranged upstream of the peak load adsorption facility 3 and/or of the main adsorption facility 2, as indicated above. In particular it is possible that the peak load adsorption facility 3 and the main adsorption facility 2 are arranged downstream of the further processing and/or treatment facility, especially of the plurality of further preparation and/or treatment facilities.

In relation to the additional use of the preparation or treatment facilities in question, especially as defined above, a possible procedure in the invention in particular is that on exceedance of the mandated concentration limit, especially incoming concentration limit, the peak load adsorption facility 3 is interposed and/or engaged downstream of the further processing and/or treatment facility, especially of the plurality of further preparation and/or treatment facilities, on the one hand, and upstream of the main adsorption facility 2, on the other hand.

In this connection, in particular, in other words, on exceedance of the mandated concentration limit, especially incoming concentration limit, it is possible that the water A to be treated and/or purified, after traversing and/or passing through the further processing and/or treatment facility or facilities, is supplied at least partially, preferably completely, first to the peak load adsorption facility 3, and is treated and/or purified in the peak load adsorption facility 3, in particular by the contaminants being adsorptively removed at least partially, and preferably by the concentration increase of the contaminants being attenuated and/or evened out, and is subsequently supplied to the main adsorption facility 2 and is treated and/or purified in the main adsorption facility 2.

In particular it is possible in accordance with the invention that the peak load adsorption facility 3 or the main adsorption facility 2, respectively, are arranged downstream of the preliminary and/or coarse filter apparatus and/or of the flocculation and/or sedimentation apparatus and/or of the fine filter apparatus and/or of the basic adsorption apparatus, especially downstream of the basic adsorption facility.

In other words, in accordance with the invention, and in relation to the optional use of the processing and/or treatment facility or facilities in question, it may be that the water A to be treated and/or purified, on exceedance of the mandated concentration limit, especially incoming concentration limit, after traversing and/or passing through the further processing and/or treatment facility or facilities, is supplied at least partially, preferably completely, first to the peak load adsorption facility 3, and is treated and/or purified in the peak load adsorption facility 3, in particular by the contaminants being adsorptively removed at least partially, and preferably by the concentration increase of the contaminants being attenuated and/or evened out, and is subsequently supplied to the main adsorption facility 2 and is treated and/or purified in the main adsorption facility 2.

Accordingly, the water purification plant 1 as such may be designed directly in the form of a total water purification plant, especially as set up above.

In another embodiment of the present invention, it is also possible that the water purification plant 1 is arranged or operated and/or charged downstream of a total water purification plant. In this connection, it may in particular be that the water purification plant 1 is arranged or operated and/or charged at the downstream last position or, in particular based on the process or operational direction, at the end and/or outlet of the total water purification plant (inserted upstream or arranged downstream thereof). In this way, in the context of the present invention, existing water purification plants can be supplemented or retrofitted with the water purification plant 1 of the invention in order to provide a relevant total water processing plant. The method of the invention can also be employed correspondingly in this context.

In this context, therefore, the water purification plant 1 can be used for the final or concluding treatment and/or purification of the water A to be treated and/or purified, and especially in the context of the supplementation or retrofitting of a relevant total water purification plant.

In this context, it is also possible in accordance with the invention that the total water purification plant comprises at least one processing and/or treatment facility, especially as defined above for the water purification plant 1. Thus the total water purification plant may comprise (i) at least one especially mechanical—preliminary and/or coarse filter facility, (ii) at least one flocculation and/or sedimentation facility, (iii) at least one—especially mechanical—fine filter facility, and (iv) optionally at least one basic adsorption facility, especially in the above order (i) to (iv), based on the process or operational direction.

According to this embodiment of the present invention, a possible procedure in particular is that on exceedance of the mandated concentration unit, especially incoming concentration limit, the peak load adsorption facility 3 is interposed and/or engaged downstream of the further processing and/or treatment facility, especially the plurality of further preparation and/or treatment facilities, of the total water purification plant, on the one hand, and upstream of the main adsorption facility 2, on the other hand.

In accordance with the invention, therefore, it is possible that—as indicated above—the water purification plant 1 is integrated into a total water purification plant. On this basis in particular the possibility arises of retrofitting existing plants with relevant optimization of the removal of contaminants, especially, in particular, with regard to the concentration increases of present contaminants or of contaminants which give rise to time-limited or spontaneous concentration increases. In this context, therefore, existing plants can be provided with an optimized purification performance, allowing existing plants, so to speak, to be functionally supplemented or expanded.

In relation to the above-indicated further preparation and/or treatment facilities, it is possible in general (i.e., both on furnishing of the water purification plant 1 as such with the relevant preparation and/or treatment facilities, and also in the presence of a total water purification plant with the relevant preparation and/or treatment facilities and retrofitted or supplemented water purification plant 1) that the water A to be treated and/or purified, before supply and/or feed into the peak load adsorption facility 3 and before supply and/or feed into the main adsorption facility 2 and/or before supply and/or feed into the water purification plant 1, is first guided and/or passed (i) through and/or into the—especially mechanical—preliminary and/or coarse filter facility and/or (ii) through and/or into the flocculation and/or sedimentation facility and/or (iii) through and/or into the mechanical fine filter facility and/or (iv) through and/or into the basic adsorption facility.

With regard, moreover, to the concentration limit, especially incoming concentration limit, is it possible that it is measured and/or captured in general continuously or discontinuously, especially discontinuously, as for example by continuous or discontinuous sampling from the water A to be treated or purified, especially upstream of the peak load adsorption facility 3 and the main adsorption facility 2.

In particular, it is possible that the mandated concentration limit, especially mandated incoming concentration limit, is measured and/or captured in at least substantially regular time intervals, especially in time intervals in a range from 10 s to 300 min, preferably in a range from 30 s to 240 min, more preferably in a range from 1 min to 180 min, very preferably in a range from 5 min to 120 min, especially preferably in a range from 10 min to 60 min, with further preference in a range from 15 min to 40 min, especially discontinuously.

In accordance with the invention it is possible that the mandated concentration limit, especially mandated incoming concentration limit, is measured and/or captured as part of or by means of an online measurement and/or online capture.

In general it is possible that the concentration limit, especially incoming concentration limit, is measured and/or captured upstream of the peak load adsorption facility 3 and of the main adsorption facility 2.

In particular it is possible that the concentration limit, especially incoming concentration limit, is measured and/or captured at the upstream first position and/or, especially based on the process and/or operational direction, at the start and/or at the inlet of the water purification plant 1 and/or of the total water purification plant.

In accordance with the invention it is possible that the concentration limit, especially incoming concentration limit, is measured and/or captured on the water A, especially raw, untreated water, to be treated and/or purified, preferably before implementation of the treatment and/or purification or at most after implementation of a mechanical treatment and/or purification, especially coarse filtration.

In this context it is inventively preferred to perform the measurement or capture of the concentration limit, especially incoming concentration limit, as far as possible upstream or at the beginning of the process or operational direction. This is also advantageous insofar as, especially in relation to a discontinuous measurement or capture of the value in question, because of the corresponding flow path and/or flow time of the water A for treatment or purification, up to the peak load adsorption facility 3 or main adsorption facility 2, respectively, there remains sufficient time to either engage the peak load adsorption facility 3 (on exceedance of the concentration limit, especially incoming concentration limit) or disengage it (on shortfall of the concentration limit, especially incoming concentration limit). Because of this as well a discontinuous measurement value capture may be realized, which is generally an advantage in terms of process economics and costs. Where the inventively employed water purification plant 1 or the above-described total water purification plant includes the additional deployment of preparation and/or treatment facilities, as described above, the capture of measurement values may also take place, in particular, downstream of a mechanical preliminary or coarse filter apparatus and upstream of an optionally following apparatus of the processing and/or treatment facility (e.g., upstream of the flocculation and/or sedimentation apparatus) and/or upstream of a further processing and/or treatment facility and/or upstream of the peak load adsorption facility 3 or the main adsorption facility 2, respectively.

To capture the concentration limit, especially incoming concentration limit, it is possible to use measurement/capture facilities that are known per se to a person skilled in the art. In particular it is possible that the concentration limit, especially incoming concentration limit, is measured and/or captured chromatographically, especially using high-performance liquid chromatography (HPLC) methods.

In accordance with the invention it is possible that the concentration limit, especially incoming concentration limit, is measured and/or captured by means of at least one contamination measuring facility 4. It is possible that the contamination measuring facility 4 used comprises a chromatography contamination measuring facility, especially a high-performance liquid chromatography contamination measuring facility.

It is also possible in accordance with the invention that the water A to be treated and/or purified and/or the treated and/or purified water B is transported via at least one transport facility 5a, 5b, 5c, 5d, especially pipeline facility. For this purpose it is possible for example to use at least one pumping facility.

In particular it is possible that the water A to be treated and/or purified is transported via at least one first transport facility 5a, especially first pipeline facility, in particular by being supplied to the main adsorption facility 2. In this regard it is possible that the first transport facility 5a is connected to the main adsorption facility 2, especially to the entry of the main adsorption facility 2, the connection especially being switchable and/or regulatable, preferably engageable and disengageable.

With further regard to the method of the invention, it is possible that the water A to be treated and/or purified, on exceedance of the mandated concentration limit, especially incoming concentration limit, and/or before traveling and/or traversing the peak load adsorption facility 3, is transported via at least one second transport facility 5b, especially second pipeline facility, in particular by being supplied to the peak load adsorption facility 3. In this respect, it is possible that the second transport facility 5b is connected to the first transport facility 5a. For this purpose it is possible that the second transport facility 5b is connected to the peak load adsorption facility 3, especially to the entry of the peak load adsorption facility 3, the connection especially being switchable and/or regulatable, preferably engageable and disengageable.

It is possible, moreover, that the water A to be treated and/or purified, on exceedance of the mandated concentration limit, especially incoming concentration limit, and/or before traveling and/or traversing the peak load adsorption facility 3, is transported via at least one third transport facility 5c, especially third pipeline facility, in particular by being supplied to the main adsorption facility 2. In this connection it is possible that the third transport facility 5c is connected to the first transport facility 5a, especially downstream of the connection of the second transport facility 5b to the first transport facility 5a.

Moreover it is possible that the third transport facility 5c is connected to the peak load adsorption facility 3, especially to the outlet of the peak load adsorption facility 3, the connection especially being switchable and/or regulatable, preferably engageable and disengageable.

It is possible, furthermore, that the treated and/or purified water B, especially after traveling and/or traversing the main adsorption facility 2, is transported via at least one fourth transport facility 5d, especially fourth pipeline facility, especially where the fourth transport facility 5d is connected to the main adsorption facility 2, especially to the outlet of the main adsorption facility 2. The particular function of the fourth transport facility 5d is to transport away the treated or purified water B.

In accordance with the invention it is possible that the engagement and/or upstream insertion of the peak load adsorption facility 3 is carried out and/or regulated by means of at least one regulating facility 6a, 6b, 6c, especially flow regulating facility, especially valve facility, preferably by means of a plurality of regulating facilities 6a, 6b, 6c, more preferably by means of a first regulating facility 6a, a second regulating facility 6b, and a third regulating facility 6c.

In this connection it is possible that the regulating facility or facilities 6a, 6b, 6c are arranged on the transport facilities 5a, 5b, 5c, especially on the first transport facility 5a and/or on the second transport facility 5b and/or on the third transport facility 5c. By these means it is possible that the flow of the water A to be treated and/or purified through the first transport facility 5a and/or through the second transport facility 5b and/or through the third transport facility 5c is regulated. It is also possible by these means that the flow of the water A to be treated and/or purified through the peak load adsorption facility 3 and/or through the main adsorption facility 2 is regulated.

In general it is possible that the first regulating facility 6a is arranged on the first transport facility 5a and the second regulating facility 6b is arranged on the second transport facility 5b and the third regulating facility 6c is arranged on the third transport facility 5c.

It is also possible that the first regulating facility 6a is arranged parallel to the second regulating facility 6b, the peak load adsorption facility 3, and the third regulating facility 6c.

Moreover, it is possible that the second regulating facility 6b is arranged upstream of the peak load adsorption facility 3, and the third regulating facility 6c is arranged downstream of the peak load adsorption facility 3.

In general it is possible that the regulating facilities 6a, 6b, 6c are configured as bypass circuit and/or bypass regulation. This allows the peak load adsorption facility 3 to be engaged and disengaged, respectively. In general it is possible to use bypass valves or bypass valve arrangements that are well known as such to a person skilled in the art.

In accordance with the invention it is possible that the controlling of the regulating facilities 6a, 6b, 6c is carried out by means of at least one control facility 7. For this purpose it is possible that the control facility 7 is part of the contamination measuring facility 4. In accordance with the invention, however, it is preferable if the control facility 7 is configured as an independent and/or separate facility. In this case it is possible that the control facility 7 is positioned between the contamination measuring facility 4 and the regulating facilities 6a, 6b, 6c.

With the aid of the control facility 7, therefore, it is possible to control the regulating facilities 6a, 6b, 6c as a function of the previously measured/captured concentration limit, especially incoming concentration limit, more particularly in such a way that on exceedance of the concentration limit, especially incoming concentration limit, the regulating facilities 6a, 6b, 6c are set in such a way that the peak load adsorption facility 3 is engaged and/or inserted upstream of the main adsorption facility 2. Correspondingly, in the case of shortfall of the relevant concentration limit, the regulating facilities 6a, 6b, 6c are controlled via the control facility 7 such that the peak load adsorption facility 3 is disengaged or bridged over.

In accordance with the invention, moreover, it is possible that the peak load adsorption facility 3 comprises a plurality of peak load adsorption filter subunits 3a, 3b, 3c. For example, the peak load adsorption facility 3 may comprise two, three or more peak load adsorption filter subunits 3a, 3b, 3c. In this regard, reference may also be made to statements below.

In this connection, it is possible that the peak load adsorption filter subunits are arranged or connected parallel to one another, especially fluidically parallel to one another, especially such that the peak load adsorption filter subunits 3a, 3b, 3c are arranged and/or connected in the peak load adsorption facility 3, parallel to one another, especially fluidically parallel to one another, especially such that through the respective peak load adsorption filter subunits 3a, 3b, 3c it is possible to guide at least a divisional stream of the water A to be treated and/or purified that is guided through the peak load adsorption facility 3.

It is also possible that the particulate adsorption material, especially the particulate activated carbon, preferably the granular activated carbon, more preferably the spherical activated carbon, especially as defined hereinafter, is divided, especially quantitatively and/or volumetrically, between the respective peak load adsorption filter subunits 3a, 3b, 3c, in particular by being divided at least substantially uniformly.

In this connection, it is possible in accordance with the invention that the respective peak load adsorption filter subunits 3a, 3b, 3c, independently of one another, comprise a fixed bed filter and/or a fixed bed based on the particulate adsorption material, especially the particulate activated carbon, preferably the granular activated carbon, more preferably the spherical activated carbon, especially as defined below.

In general it is possible that the peak load adsorption facility 3 comprises at least 2 and/or especially 2 to 10, preferably 2 to 8, more preferably 3 to 6, very preferably 5, peak load adsorption filter subunits 3a, 3b, 3c.

In particular it is possible that the peak load adsorption filter subunits 3a, 3b, 3c, independently of one another, are engageable and disengageable or are configured in such a way. In particular for this purpose it may be the case that regulating facilities 8a, 8b, 8c and, respectively, 9a, 9b, 9c of the peak load adsorption filter subunits 3a, 3b, 3c are used. In that case the further regulating facilities 8a, 8b, 8c may be inserted upstream or arranged upstream of the respective peak load adsorption filter subunits 3a, 3b, 3c, and/or the further regulating facilities 9a, 9b, 9c may be inserted downstream or arranged downstream of the respective peak load adsorption filter subunits 3a, 3b, 3c. In this connection it is also possible to use at least one peak load adsorption filter subunit control facility to drive the further regulating facilities 8a, 8b, 8c and, respectively, 9a, 9b, 9c.

It is also possible in accordance with the invention that at least one peak load adsorption filter subunit 3a, 3b, 3c, especially for purposes of replacement of, in particular, spent and/or exhausted particulate adsorption material, especially spent and/or exhausted particulate activated carbon, preferably spent and/or exhausted granular activated carbon, more preferably spent and/or exhausted spherical activated carbon, can be separated and/or isolated from the flow of the water A to be treated and/or purified and/or is not flow-traversable for the water A to be treated and/or purified.

Lastly it is also possible that at least one peak load adsorption filter subunit 3a, 3b, 3c, especially for purposes of provision of a reserve adsorption filter capacity, can be engaged to the flow of the water A to be treated and/or purified and/or is additionally flow-traversable by the water A to be treated and/or purified.

As indicated above, it is possible overall by virtue of the design approach of the invention to reduce the number of peak load adsorption filter subunits 3a, 3b, 3c. Because of the possibility of engaging/disengaging the respective peak load adsorption filter subunits 3a, 3b, 3c, continuous operation of the water purification plant 1 of the invention is also ensured.

It is also possible, furthermore, that the main adsorption facility 2 comprises a plurality of main adsorption filter subunits 2a, 2b, 2c, 2d, 2e, 2f. In this respect the main adsorption facility 2 may be subdivided by the/into the main adsorption filter subunits 2a, 2b, 2c, 2d, 2e, 2f. For example, the main adsorption facility 2 may comprise two, three, four, five, six or more main adsorption filter subunits 2a, 2b, 2c, 2d, 2e, 2f. In this regard, reference may also be made to statements below.

It is also possible that the main adsorption filter subunits 2a to 2f are arranged and/or connected in the main adsorption facility 2 parallel to one another, especially fluidically parallel to one another, especially such that at least a divisional stream of the water A to be treated and/or purified that is guided through the main adsorption facility 2 can be guided through the respective main adsorption filter subunits 2a to 2f.

In accordance with the invention it is possible that the particulate adsorption material, especially the particulate activated carbon, preferably the granular activated carbon, more preferably the spherical activated carbon, especially as defined below, of the main adsorption facility 2 is divided between the respective main adsorption filter subunits 2a to 2f, in particular by being divided at least substantially uniformly.

It is possible, moreover, that the respective main adsorption filter subunits 2a to 2f, independently of one another, comprise a fixed bed filter and/or a fixed bed based on the particulate adsorption material, especially the particulate activated carbon, preferably the granular activated carbon, more preferably the spherical activated carbon, especially as defined below.

It is also possible that the main adsorption facility 2 comprises at least 2 and/or especially 2 to 30, preferably 4 to 20, more preferably 5 to 15, very preferably 10, main adsorption filter subunits 2a, 2b, 2c, 2d, 2e, 2f.

On the basis of the design approach of the invention, it is also possible to reduce correspondingly the number of main adsorption filter subunits 2a to 2f on which the main adsorption facility 2 is based, especially through the underlying relief through engageable peak load adsorption facility 3.

It is also possible that the main adsorption filter subunits 2a to 2f, independently of one another, are engageable and disengageable or are configured in such a way.

In this connection it is also possible to use further regulating facilities 10a, 10b, 10c, 10d, 10e, 10f and, respectively, 11a, 11b, 11c, 11d, 11e, 11f of the main adsorption filter subunits 2a, 2b, 2c, 2d, 2e, 2f, especially where the further regulating facilities 10a to 10f are inserted or arranged upstream of the respective main adsorption filter subunits 2a to 2f and/or the further regulating facilities 11a to 11f are inserted or arranged downstream of the respective main adsorption filter subunits 2a to 2f. In this connection it is also possible to use at least one main adsorption filter subunit control facility for driving the further regulating facilities 10a to 10f and/or 11a to 11f.

In accordance with the invention it is possible that, in particular on the basis of the engageability and disengageability, at least one main adsorption filter subunit 2a to 2f, especially for purposes of replacement of, in particular, spent and/or exhausted particulate adsorption material, especially spent and/or exhausted particulate activated carbon, preferably spent and/or exhausted granular activated carbon, more preferably spent and/or exhausted spherical activated carbon, can be separated and/or isolated from the flow of the water A to be treated and/or purified and/or is not flow-traversable for the water A to be treated and/or purified.

In this connection it is also possible that, especially on the basis of the engageability and disengageability, at least one main adsorption filter subunit 2a to 2f, especially for purposes of provision of a reserve adsorption filter capacity, can be engaged to the flow of the water A to be treated and/or purified and/or is additionally flow-traversable by the water A to be treated and/or purified.

In general, the loaded or exhausted adsorption material taken from the method may be subjected to regeneration or recycling and may subsequently be supplied again to the method of the invention and/or the relevant facilities, especially the peak load adsorption facility 3 and/or the main adsorption facility 2.

According to a further inventive embodiment, moreover, it may be the case that the water purification plant 1 comprises at least one further peak load adsorption facility 3′, especially engageable as a function of a concentration limit, measured and/or captured downstream of the peak load adsorption facility 3, of the contaminants in the water A to be treated and/or purified, where the further peak load adsorption facility 3′ is arranged downstream of the peak load adsorption facility 3 and upstream of the main adsorption facility 2 and where on exceedance of a mandated further concentration limit, especially measured and/or captured downstream of the peak load adsorption facility 3, the further peak load adsorption facility 3′ is engaged and/or is inserted downstream of the peak load adsorption facility 3 and inserted upstream of the main adsorption facility 2, in such a way that the water A to be treated and/or purified is supplied at least partially, preferably completely, additionally and subsequently to the peak load adsorption facility 3 and before entry or transfer into the main adsorption facility 2, to the further peak load adsorption facility 3′ and is also treated and/or purified in the further peak load adsorption facility 3′, additionally and subsequently to the peak load adsorption facility 3 and before entry into the main adsorption facility 2, in particular by the contaminants still remaining being adsorptively at least partially removed, preferably by the concentration rise of the contaminants being further attenuated and/or evened out.

Accordingly, it is the case in particular in the present invention that the peak load adsorption facility 3 and also the optional further peak load adsorption facility 3′ are connected in series.

The further concentration limit may be captured and/or measured downstream of the first peak load adsorption facility 3 and upstream of the further peak load adsorption facility 3′. Accordingly, especially when very high/very long-lasting concentration increases of the contaminants are present, the further peak load adsorption facility 3′ can be engaged when needed, especially for purposes of further attenuation or evening-out of the concentration increase, in association with a further purification of the water A to be treated and/or purified that has been previously guided through the peak load adsorption facility 3.

Generally speaking, moreover, at least one yet further concentration limit can be measured and/or captured downstream of the peak load adsorption facility 3 (or downstream of the optional further peak load adsorption facility 3′) and/or upstream of the main adsorption facility 2, especially for monitoring the purification effect of the peak load adsorption facility 3. In this context, on exceedance of the relevant concentration limit, the method may also be carried out, in particular, in such a way that at least one divisional stream, preferably the total stream, of the water previously guided through the peak load adsorption facility 3 is supplied again to the peak load adsorption facility 3.

For the measurement or capture of the (yet) further concentration limit it is possible optionally to use at least one further contamination measuring facility 4′. For this purpose a chromatography contamination measuring facility may be used, especially a high-performance liquid chromatography contamination measuring facility. In particular the further contamination measuring facility 4′ may be arranged downstream of the peak load adsorption facility 3 (or downstream of the optional further peak load adsorption facility 3′) and/or upstream of the main adsorption facility 2.

In accordance with the invention, moreover, it is possible that further regulating facilities 6d, 6e are used, especially for regulating the flow through the further peak load adsorption facility 3′. In this context, the further regulating facilities 6d, 6e may be arranged on further transport facilities 5e, 5f. Moreover, the further regulating facilities 6d, 6e may be controlled by a further control facility 7′. In this context, the further control facility 7′ may also control the regulating facility 6c, which may be arranged downstream of the peak load adsorption facility 3 and/or upstream of the further peak load adsorption facility 3′.

Moreover, the further peak load adsorption facility 3′ may optionally comprise further peak load adsorption filter subunits 3a′, 3b′, 3c′, which in particular may be arranged parallel to one another. To regulate the flow through the further peak load adsorption filter subunits 3a′, 3b′, 3c′, moreover, it is possible that further regulating facilities 8a′, 8b′, 8c′, which may be inserted upstream or arranged upstream of the further peak load adsorption filter subunits 3a′, 3b′, 3c′, and/or further regulating facilities 9a′, 9b′, 9c′, which in particular may be inserted or arranged downstream of the further peak load adsorption filter subunits 3a′ 3b′, 3c′, are used.

Additionally, in accordance with the invention, it is possible that the outgoing concentration limit is measured or captured downstream of the main adsorption facility 2. In particular, the outgoing concentration limit, especially relative to the process or operational direction, may be measured or captured at the end or at the outlet of the water purification plant 1 or of the total water purification plant. In this regard, at least one outlet contamination measuring facility, especially as defined above, can be used. The outlet contamination measuring facility may in particular be arranged downstream of the main adsorption facility 2. In the invention the outlet contamination measuring facility can be used in the form of a chromatography contamination measuring facility, especially high-performance liquid chromatography contamination measuring facility. On the basis of the outgoing concentration limit or its determination it is therefore possible to a certain extent for there to be a final monitoring of the treatment or purification implemented on the relevant water A. In this context it is also possible in particular to proceed in such a way that on exceedance of the mandated outgoing concentration limit, the treated or purified water is supplied again at least partly, preferably completely, to the water purification plant 1, especially to the peak load adsorption facility 3 and/or to the main adsorption facility 2.

With regard to the contaminants to be removed in the method of the invention, the situation may in particular be as follows:

It is possible accordingly that the contaminants, especially the organic contaminants, preferably the micronoxiants and/or the trace substances, are selected from the group of (i) agriculturally utilized and/or arising chemicals, especially pesticides, such as metaldehyde; fungicides and insecticides; (ii) industrially utilized and/or arising chemicals and/or industrial chemicals, especially plasticizers, such as bisphenol-A; x-ray contrast agents, such as amidotrizoic acid and iopamidol; surfactants, such as perfluorinated surfactants; antiknock agents, such as methyl tert-butyl ether (MTBE); and Dissolved Organic Carbons (DOCs); and (iii) active pharmaceutical ingredients and/or human and/or veterinary drugs, especially antibiotics; analgesics and active hormone ingredients; preferably from the group of agriculturally utilized and/or arising chemicals, especially pesticides, such as metaldehyde; fungicides and insecticides.

In the method of the invention, then, a large multiplicity of different contaminants can be removed from the water A to be treated or purified, and so the method of the invention exhibits a corresponding breadth of utility. In the present invention it is equally and particularly possible to carry out adsorptive removal of specific agriculturally utilized or agriculturally arising chemicals, especially pesticides, as for example metaldehyde, more particularly also with regard to the large amounts of such contaminants that arise in the case of concentration increases.

In relation to the method of the invention, therefore, it is possible in particular to proceed in such a way that the concentration limit, especially incoming concentration limit, and/or the corresponding outgoing concentration limit relates to a specific substance of the contaminants, such as pesticides, for example, especially in the form of metaldehyde.

With regard to the mandated concentration limit in question, especially incoming concentration limit, it may be set—further to the statements above—in particular to a value of 0.1 μg/l or more, in relation, for example, to a pesticide, especially in the form of metaldehyde. Accordingly, in the method of the invention, on exceedance of the above-stated mandated limits, especially incoming concentration limits, the relevant peak load adsorption facility 3 is engaged and/or is inserted upstream of the main adsorption facility 2, and/or the adsorption filter facility 3 is disengaged or bridged over on shortfall or nonattainment.

A further possible procedure in the present invention is such that the optionally mandated (yet) further concentration limit, especially as defined above, is set to a value which is smaller than the corresponding value of the incoming concentration limit. For example, the relevant further limit may be mandated to a value of greater than 0.05 μg/l to less than 0.1 μg/l. On exceedance of the limit in question, the procedure in accordance with the invention may be such that the water to be treated and/or purified is supplied again to the peak load adsorption facility 3 or else additionally to the optional further peak load adsorption facility 3′.

Lastly, the outgoing concentration limit may be mandated to a value, for example, of 0.05 μg/l or less.

In particular, the treated or purified water B obtained in the method of the invention may comprise an amount or concentration of contaminants of at most 0.1 μg/l, especially at most 0.08 μg/l, preferably at most 0.05 μg/l, especially based on the pesticides, particularly metaldehyde, that are present in the treated or purified water B.

In terms of the method of the invention, great significance also attaches to the particulate adsorption material employed for the method, especially in relation to the provision of a high adsorptive cleaning efficiency or cleaning specificity, particularly in relation to the adsorption of specific contaminants, such as of pesticides, especially metaldehyde:

In this connection it is possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, are obtainable by carbonization and subsequent activation of a synthetic and/or non-naturally based starting material, especially based on organic polymers.

It is also possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, are obtained from a starting material based on organic polymers, especially based on sulfonated organic polymers, preferably based on divinylbenzene-crosslinked polystyrene, more preferably based on styrene/divinylbenzene copolymers, especially by carbonization and subsequent activation of the starting material, especially where the divinylbenzene content of the starting material is in the range from 1 wt % to 20 wt %, especially 1 wt % to 15 wt %, preferably 1.5 wt % to 12.5 wt %, more preferably 2 wt % to 10 wt %, based on the starting material.

In this connection it is possible that the starting material is an especially sulfonated and/or sulfo-containing ion exchange resin, especially of the gel type.

It is equally possible that particulate adsorption material, especially particulate activated carbon, preferably granular activated carbon, more preferably spherical activated carbon, of the peak load adsorption facility 3 and particulate adsorption material, especially particulate activated carbon, preferably granular activated carbon, more preferably spherical activated carbon, of the main adsorption facility 2, independently of one another, that are used comprise a polymer-based spherical activated carbon (PBSAC).

The activated carbon used may here be obtained in principle by known processes of the prior art: for this purpose, in particular, spherical sulfonated organic polymers, especially based on divinylbenzene-crosslinked polystyrene, are carbonized and then activated to form the relevant activated carbon, especially as indicated above. For further details in this regard, reference may be made, for example, to DE 43 28 219 A1, DE 43 04 026 A1, DE 196 00 237 A1, and also to EP 1 918 022 A1 or to the parallel US 2008/0107589 A1, which belongs to the same patent family; the respective content of these patents is included in its entirety hereby by reference.

Activated carbons employed in the present invention are in general available commercially or commercially customary. In particular it is possible to employ activated carbons which are sold by Bliicher GmbH, Erkrath, Germany, for example.

The inventively employed adsorption materials, especially activated carbons, as well as their outstanding physical properties (i.e., high mechanical stability, low abrasion/low dusting and consequently outstanding transport properties both within the heap and in the regeneration process), also, furthermore, have outstanding adsorption properties in relation to the contaminants to be removed from the water to be treated or purified. More particularly it is possible in the context of the present invention to use an activated carbon which has been tailored to some degree, and which takes account of the complexity, the molecule sizes, and the specific polarities of the contaminants or micronoxiants to be removed and the way that this influences the adsorption behavior. Especially taking account of the polarities and of the hydrate shells of the corresponding molecule size that result in the water phase, great significance attaches to the contaminants that are to be removed, insofar as a very specific adsorption pore system with a matched specific surface chemistry of the adsorption material or of the activated carbon used is advantageous for optimum adsorption. As indicated above, the adsorption materials or activated carbons used in the present invention may to a certain extent be individually adapted or tailored in this regard, leading to further optimization of the adsorption properties. As a consequence, significant advantages also result relative to conventional adsorption materials, especially with regard to the adsorption performance, adsorption selectivity, and the associated service lives or deployment times, which also leads to reduced costs overall.

In accordance with the invention, therefore, it is possible in particular that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a bulk density in a range from 100 g/l to 900 g/l, especially in a range from 350 g/l to 750 g/l, preferably in a range from 375 g/l to 625 g/l, more preferably in a range from 415 g/l to 550 g/l.

Moreover, it is possible in the invention that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a tapped and tamped density in the range from 150 g/l to 1500 g/l, especially in the range from 300 g/l to 1250 g/l, preferably in the range from 350 g/l to 900 g/l, more preferably in the range from 400 g/l to 700 g/l, very preferably in the range from 425 g/l to 600 g/l.

The bulk density or tapped and/or tamped density may be determined in particular according to ASTM B527-93/00. The tapped or tamped density as such may in particular also be determined according to DIN 53194.

Moreover it is possible in the invention that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a ball pan hardness and/or abrasion hardness of at least 92%, especially at least 95%, preferably at least 96%, more preferably at least 97%, very preferably at least 97.5%, with further preference at least 98%, with even further preference at least 98.5%, with yet further preference at least 99%.

In particular it is possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a compressive strength or bursting strength (weight-bearing capacity) per adsorption particle, especially per activated carbon particle, of at least newtons, especially at least 10 newtons, preferably at least 15 newtons, more preferably at least 20 newtons, and/or a compressive strength and/or bursting strength (weight-bearing capacity) per adsorption particle, especially per activated carbon particle, in the range from 5 to 50 newtons, especially 10 to 45 newtons, preferably 15 to 40 newtons.

The inventively employed activated carbon is therefore further characterized by outstanding mechanical properties, which is also reflected in the high abrasion resistance. In terms of the application, the high mechanical strength of the inventively employed activated carbon leads at most to small levels of abrasion, this being an advantage in particular in terms of the deployment time or service life and also the prevention of sludge formed by abrasion, or the like, especially in the case of filter systems for the processing of water. The abrasion resistance or abrasion hardness may be determined in general according to ASTM D3802-05.

The compressive strength or bursting strength may be determined in a manner known per se to a person skilled in the art, especially by way of determination of the compressive or bursting strength on individual particles or corpuscles by exposure to force mediated by a die to the bursting point of the respective particle or corpuscle.

In accordance with the invention, moreover, it is possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a water content and/or moisture content in the range from 0.005 wt % to 2.5 wt %, especially in the range from 0.01 wt % to 1.5 wt %, preferably in the range from 0.05 wt % to 1 wt %, more preferably in the range from 0.075 wt % to 0.75 wt %, very more preferably in the range from 0.08 wt % to 0.5 wt %, based on the particulate adsorption material, especially the particulate activated carbon. Such activated carbons are especially suitable for the purpose of the invention. The relevant determination may be made in particular according to ASTM D2867-04.

Furthermore, it is also possible in accordance with the invention that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have an ash content of at most 1 wt %, especially at most 0.9 wt %, preferably at most 0.8 wt %, more preferably at most 0.7 wt %, very preferably at most 0.5 wt %, especially preferably at most 0.3 wt %, with further preference at most 0.2 wt %, based on the particulate adsorption material, especially the particulate activated carbon. The ash content of the inventively preferably employed activated carbon may be determined in particular according to ASTM D2866-94/04.

It is further preferred within the present invention if the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a particle size, especially a corpuscle diameter, in a range from 0.01 mm to 2.5 mm, especially in a range from 0.02 mm to 2 mm, more preferably in a range from 0.05 mm to 1.5 mm, preferably in a range from 0.1 mm to 1 mm, very preferably in a range from 0.2 mm to 0.8 mm, especially preferably in a range from 0.3 mm to 0.6 mm, especially where at least 70 wt %, especially at least 80 wt %, of the adsorption particles, especially of the activated carbon particles, have particle sizes, especially corpuscle diameters, in the aforesaid ranges.

In this context it is possible in accordance with the invention that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a median particle size D50, especially a median corpuscle diameter D50, in the range from 0.15 mm to 1.15 mm, especially 0.2 mm to 1 mm, preferably 0.25 mm to 0.85 mm, more preferably 0.3 mm to 0.7 mm, very more preferably 0.35 mm to 0.55 mm.

The corpuscle sizes and diameters in question may be determined in particular on the basis of the method according to ASTM D2862-97/04. Moreover, the aforesaid variables may be determined by determination methods based on a sieve analysis, based on x-ray diffraction, laser diffractometry or the like, and determination by means of a Camsizer is also possible.

The respective determination methods are well known per se to a person skilled in the art, and so no further statements are required in this regard. The selection of specific corpuscle sizes or corpuscle diameters, in the light of the present invention, leads to a particularly uniform heap within the plant and also to a further-improved flow behavior of the water in the heap.

With further regard to the adsorption material employed preferably in accordance with the invention, moreover, it is possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a specific surface area (BET surface area) of at least 600 m²/g, especially at least 900 m²/g, preferably at least 1200 m²/g, more preferably at least 1400 m²/g. In this context it is also possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a specific surface area (BET surface area) in a range from 600 m²/g to 3750 m²/g, especially in a range from 900 m²/g to 3000 m²/g, preferably in a range from 1200 m²/g to 2250 m²/g, more preferably in a range from 1400 m²/g to 2000 m²/g.

The determination of the BET specific surface area is known in principle to a person skilled in the art. All BET surface area figures are based especially on the determination as per ASTM D6556-04. In the present invention, the BET surface area is determined using, in particular, the multipoint BET determination method (MP-BET) within a partial pressure range p/p₀ from 0.05 to 0.1.

Correspondingly it is possible in the invention that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a Gurvich total pore volume of at least 0.55 cm³/g, especially at least 0.65 cm³/g, preferably at least 0.7 cm³/g, more preferably at least 0.75 cm³/g, very preferably at least 0.8 cm³/g. In this connection it may also be the case that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have a Gurvich total pore volume in a range from 0.55 cm³/g to 2.2 cm³/g, especially in a range from 0.65 cm³/g to 2 cm³/g, preferably in a range from 0.7 cm³/g to 1.5 cm³/g, more preferably in a range from 0.8 cm³/g to 1.2 cm³/g.

The determination of Gurvich total pore volume is a method of measurement or determination that is known per se to a person skilled in the art in this field. For further details regarding the determination of the Gurvich total pore volume see, for example, L. Gurvich (1915), J. Phys. Chem. Soc. Russ. 47 805, and also S. Lowell et al., Characterization of Porous Solids and Powders: Surface Area Pore Size and Density, Kluwer Academic Publishers, Article Technologies Series, pages 111 ff.

In accordance with the invention, moreover, it is possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have an iodine number of at least 1100 mg/g, especially at least 1300 mg/g, preferably at least 1525 mg/g. In this connection it may also be the case that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2, independently of one another, have an iodine number in a range from 1100 mg/g to 2000 mg/g, especially in a range from 1300 mg/g to 1950 mg/g, preferably in a range from 1525 mg/g to 1900 mg/g.

The iodine number is determined in particular according to ASTM D4607-94/99 or by means of CEFIC, Test Methods for Activated Carbon, April 1986, section 2.3.).

In one inventively preferred embodiment it is possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2 have at least substantially equal and/or identical material-related properties, especially as defined above. In this context it is possible in particular that the materials used for the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2 are at least substantially identical materials and/or materials having at least substantially identical material-related properties, especially as defined above.

Within the present invention it is also possible that the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2 differ from one another in at least one material-related property, especially as defined hereinabove.

In this connection it is possible in particular that the material-related property is selected from the group of (i) bulk density and/or tapped and tamped density; (ii) corpuscle morphology, especially particle size, preferably corpuscle diameter, and/or median particle size (D50), preferably median corpuscle diameter (D50); (iii) specific surface area, especially specific BET surface area; (iv) total pore volume, especially Gurvich total pore volume; and (v) porosity and/or pore distribution; and/or where the respective material-related property of the particulate adsorption material, especially the particulate activated carbon, preferably the granular activated carbon, more preferably the spherical activated carbon, of the peak load adsorption facility 3 and the particulate adsorption material, especially the particulate activated carbon, preferably the granular activated carbon, more preferably the spherical activated carbon, of the main adsorption facility 2 differ from one another by a factor of at least 1.05, especially a factor of at least 1.1, preferably a factor of at least 1.15, more preferably a factor of at least 1.2, very preferably a factor of at least 1.3, especially preferably a factor of at least 1.5, based in each case on the smaller value of the material-related property.

In accordance with the invention it is possible that the particulate adsorption material, especially the particulate activated carbon, preferably the granular activated carbon, more preferably the spherical activated carbon, of the peak load adsorption facility 3 has a higher activation level and/or larger specific surface area, especially BET-surface area, and/or a larger total pore volume, especially Gurvich total pore volume, than the particulate adsorption material, especially the particulate activated carbon, of the main adsorption facility 2. In this connection it is possible in particular that the particulate adsorption material, especially the particulate activated carbon, preferably the granular activated carbon, more preferably the spherical activated carbon, of the peak load adsorption facility 3 has an activation level and/or specific surface area, especially BET surface area, and/or total pore volume, especially Gurvich total pore volume, which is or are greater by a factor of at least 1.05, especially a factor of at least 1.1, preferably a factor of at least 1.15, more preferably a factor of at least 1.2, very preferably a factor of at least 1.3, especially preferably a factor of at least 1.5, than the particulate adsorption material, especially the particulate activated carbon, preferably the granular activated carbon, more preferably the spherical activated carbon, of the main adsorption facility 2.

Provided in accordance with the invention overall, then, is a powerful method for the processing or purification of water, allowing even high quantities of contaminants, present within concentration increases, to be removed effectively from the water to be purified.

The present invention further relates—according to a further aspect of the present invention—also to a water processing plant 1, especially for preferably continuous treatment and/or purification of water A, especially raw, untreated water, polluted with contaminants, especially organic contaminants, preferably micronoxiants and/or trace substances, preferably for purposes of recovering and/or obtaining treated and/or purified water B, especially clean water, preferably tap water and/or service water, preferably a water processing plant 1 for implementing a method of the invention as defined above, where the water processing plant 1 is intended and/or configured for adsorptive removal of contaminants from the water A to be treated and/or purified, preferably in the case of concentration increases of the contaminants, especially those occurring for a limited time and/or spontaneously, in the water A to be treated and/or purified,

especially where the intention is to supply the water A to be treated and/or purified to the water purification plant 1 for adsorptive removal of the contaminants,

where the water purification plant 1 comprises at least one main adsorption facility 2 and at least one peak load adsorption facility 3 which is disposed upstream of the main adsorption facility 2 and can be engaged in dependence on a mandated concentration limit, especially on a mandated incoming concentration limit, of the contaminants in the water A to be treated and/or purified,

where the water purification plant 1 is configured in such a way that the water A to be treated and/or purified is supplied to the main adsorption facility 2 and is treated and/or purified in the main adsorption facility 2, in particular by the contaminants being adsorptively removed at least substantially completely in the main adsorption facility 2, especially in such a way that the concentration of the contaminants is lowered below a mandated outgoing concentration limit, and

where the water purification plant 1 is configured in such a way that on exceedance of the mandated concentration limit, especially of the mandated incoming concentration limit, of the contaminants in the water A to be treated and/or purified, the peak load adsorption facility 3 is engaged and/or inserted upstream of the main adsorption facility 2, in such a way that the water A to be treated and/or purified is supplied at least partially, preferably completely, first to the peak load adsorption facility 3 and is treated and/or purified in the peak load adsorption facility 3, in particular by the contaminants being adsorptively removed at least partially, preferably by the concentration increase of the contaminants being attenuated and/or evened out.

In general the peak load adsorption facility 3 is configured to be engageable and/or insertable upstream of the main adsorption facility 2 in such a way that on engagement and/or upstream insertion of the peak load adsorption facility 3 the concentration of contaminants in the water A to be treated and/or purified is lowered downstream of the peak load adsorption facility 3 and/or at the outlet of the peak load adsorption facility 3, based on the process or operational direction, below the mandated concentration limit, especially the mandated incoming concentration limit.

In particular the peak load adsorption facility 3 is configured to be engageable and/or insertable upstream of the main adsorption facility 2 in such a way that on engagement and/or upstream insertion of the peak load adsorption facility 3 the concentration of contaminants in the treated and/or purified water B and/or downstream of the main adsorption facility 2 and/or at the outlet of the main adsorption facility 2, based on the process and/or operational direction, is lowered below the mandated outgoing concentration limit.

In general it is possible that the main adsorption facility 2 comprises at least one particulate adsorption material, especially a particulate activated carbon, preferably a granular activated carbon, more preferably a spherical activated carbon. In particular it is possible that the main adsorption facility 2 comprises a fixed bed filter and/or a fixed bed based on at least one particulate adsorption material, especially based on particulate activated carbon, preferably based on granular activated carbon, more preferably based on spherical activated carbon, especially in a loose heap of the particulate adsorption material.

Furthermore it is possible that the peak load adsorption facility 3 comprises at least one particulate adsorption material, especially a particulate activated carbon, preferably a granular activated carbon, more preferably a spherical activated carbon. In accordance with the invention it is possible, moreover, that the peak load adsorption facility 3 comprises a fixed bed filter and/or a fixed bed based on at least one particulate adsorption material, especially based on particulate activated carbon, preferably based on granular activated carbon, more preferably based on spherical activated carbon, especially in a loose heap of the particulate adsorption material.

In accordance with the invention, moreover, it is possible that the peak load adsorption facility 3 has a lower fixed bed filter volume V_{PLA}, especially a lower volume of the heap, of the particulate adsorption material, especially of the particulate activated carbon, preferably of the granular activated carbon, more preferably of the spherical activated carbon, and/or a lower amount of the particulate adsorption material, especially of the particulate activated carbon, preferably of the granular activated carbon, more preferably of the spherical activated carbon, than the main adsorption facility 2.

In this connection it is possible that the peak load adsorption facility 3 has a fixed bed filter volume V_{PLA}, especially a volume of the heap, of the particulate adsorption material, especially of the particulate activated carbon, preferably of the granular activated carbon, more preferably of the spherical activated carbon, of at least 0.01 m³, especially at least 0.1 m³, preferably at least 0.5 m³, more preferably at least 1 m³, very preferably at least m³, especially preferably at least 10 m³, with further preference at least 15 m³.

Equally it possible that the peak load adsorption facility 3 has a fixed bed filter volume V_{PLA}, especially a volume of the heap, of the particulate adsorption material, especially of the particulate activated carbon, preferably of the granular activated carbon, more preferably of the spherical activated carbon, in a range from 0.01 m³ to 750 m³, especially in a range from 0.1 m³ to 600 m³, preferably in a range from 0.5 m³ to 500 m³, more preferably in a range from 1 m³ to 300 m³, very preferably in a range from 5 m³ to 200 m³, especially preferably in a range from 10 m³ to 100 m³, with further preference in a range from 15 m³ to 150 m³.

Equally it is possible that the main adsorption facility 2 has a fixed bed filter volume V_{MA}, especially a volume of the heap, of the particulate adsorption material, especially of the particulate activated carbon, preferably of the granular activated carbon, more preferably of the spherical activated carbon, of at least 1 m³, especially at least 5 m³, preferably at least m³, more preferably at least 15 m³, very preferably at least 20 m³.

In this connection it is possible that the main adsorption facility 2 has a fixed bed filter volume V_{MA}, especially a volume of the heap, of the particulate adsorption material, especially of the particulate activated carbon, preferably of the granular activated carbon, more preferably of the spherical activated carbon, in a range from 1 m³ to 1500 m³, especially in a range from 5 m³ to 1000 m³, preferably in a range from 10 m³ to 800 m³, more preferably in a range from 15 m³ to 600 m³, very preferably in a range from 20 m³ to 400 m³.

Equally it is possible that the ratio of the fixed bed filter volume V_{MA}, especially of the volume of the heap, of the particulate adsorption material, especially of the particulate activated carbon, preferably of the granular activated carbon, more preferably of the spherical activated carbon, of the main adsorption facility 2, on the one hand, to the fixed bed filter volume V_{PLA}, preferably volume of the heap, of the particulate adsorption material, especially of the particulate activated carbon, preferably of the granular activated carbon, more preferably of the spherical activated carbon, of the peak load adsorption facility 3, on the other hand, is at least 1:1, especially at least 1.05:1, preferably at least 1.1:1, more preferably at least 1.2:1, very preferably at least 1.4:1, especially preferably at least 1.6:1.

In particular it is possible that the ratio of the fixed bed filter volume V_{M}A, especially of the volume of the heap, of the particulate adsorption material, especially of the particulate activated carbon, preferably of the granular activated carbon, more preferably of the spherical activated carbon, of the main adsorption facility 2, on the one hand, to the fixed bed filter volume V_{PLA}, preferably volume of the heap, of the particulate adsorption material, especially of the particulate activated carbon, preferably of the granular activated carbon, more preferably of the spherical activated carbon, of the peak load adsorption facility 3, on the other hand, is in a range from 1.05:1 to 500:1, especially in a range from 1.05:1 to 100:1, preferably in a range from 1.1:1 to 50:1, more preferably in a range from 1.2:1 to 30:1, very preferably in a range from 1.4:1 to 20:1, especially preferably in a range from 1.6:1 to 10:1, with further preference in a range from 1.8:1 to 5:1.

In general the water purification plant 1 has a service life and/or a bed volume BV of at least 1000 BV, especially at least 5000 BV, preferably at least 10 000 BV, more preferably at least 15 000 BV, very preferably at least 20 000 BV, calculated as the quotient of the volume of the treated and/or purified water V_{H2O}, on the one hand, to the sum total of the fixed bed filter volume V_{PLA}, especially of the volume of the heap, of the particulate adsorption material of the peak load adsorption facility 3 and of the fixed bed filter volume V_{MA}, especially of the volume of the heap, of the particulate adsorption material of the main adsorption facility 2, on the other hand, of [BV=V_{H2O[m}_{³}_{]}/(V_{PLA[m}_{³}_{]}+V_{MA[m}_{³}_{]})].

In particular it is possible that the water purification plant 1 has a service life and/or a bed volume BV in a range from 1000 BV to 500 000 BV, especially in a range from 5000 BV to 200 000 BV, preferably in a range from 10 000 BV to 100 000 BV, more preferably in a range from 15 000 BV to 50 000 BV, very preferably in a range from 20 000 BV to 40 000 BV, calculated as the quotient of the volume of the treated and/or purified water V_{H2O}, on the one hand, to the sum total of the fixed bed filter volume V_{PLA}, especially of the volume of the heap, of the particulate adsorption material of the peak load adsorption facility 3 and of the fixed bed filter volume V_{MA}, especially of the volume of the heap, of the particulate adsorption material of the main adsorption facility 2, on the other hand, of [BV=V_{H2O[m}_{³}_{]}/(V_{PLA[m}_{³}_{]}+V_{MA[m}_{³}_{]})].

In general it is possible that the water purification plant 1 is configured in such a way that on exceedance of the mandated concentration limit, especially incoming concentration limit, the water A to be treated and/or purified is passed and/or guided at least partially, preferably completely, first through and/or into the peak load adsorption facility 3 and passed and/or guided subsequently through and/or into the main adsorption facility 2.

Furthermore, it is possible that the water purification plant 1 is configured in such a way that on exceedance of the mandated concentration limit, especially incoming concentration limit, the total flow of the water A to be treated and/or purified, and/or the water A to be treated and/or purified, is supplied first to the peak load adsorption facility 3 and the water A to be treated and/or purified is treated and/or purified in the peak load adsorption facility 3 and is subsequently supplied to the main adsorption facility 2 and is treated and/or purified in the main adsorption facility 2.

In general it is possible that the water purification plant 1 is configured in such a way that on shortfall and/or presence and/or nonattainment of the mandated concentration limit, especially incoming concentration limit, the water A to be treated and/or purified is supplied at least substantially completely to the main adsorption facility 2 directly and/or with circumvention and/or omission of the peak load adsorption facility 3 and treated and/or purified in the main adsorption facility 2.

In general it is possible that the water purification plant 1, additionally to the main adsorption facility 2 and/or peak load adsorption facility 3, comprises at least one further processing and/or treatment facility, especially a plurality of further preparation and/or treatment facilities.

In this connection it is possible that the further processing and/or treatment facility comprises or consists of at least one—especially mechanical—preliminary and/or coarse filter facility and/or at least one flocculation and/or sedimentation facility and/or at least one—especially mechanical—fine filter facility and/or at least one basic adsorption facility.

In this regard it is possible that the further processing and/or treatment facility comprises (i) at least one—especially mechanical—preliminary and/or coarse filter facility, (ii) at least one flocculation and/or sedimentation facility, (iii) at least one—especially mechanical—fine filter facility, and (iv) optionally at least one basic adsorption facility, especially in the above order (i) to (iv), based on the process and/or operational direction.

In this connection it is possible that the water purification plant 1 is configured in such a way that on exceedance of the mandated concentration limit, especially incoming concentration limit, the peak load adsorption facility 3 is interposed and/or engaged downstream of the further processing and/or treatment facility, especially of the plurality of further preparation and/or treatment facilities, on the one hand, and upstream of the main adsorption facility 2, on the other hand.

In accordance with the invention a further possibility is that the water purification plant 1 is arranged downstream of a total water purification plant.

In this connection it is possible that the water purification plant 1 is arranged in downstream last position and/or, especially based on the process and/or operational direction, at the end and/or outlet of the total water purification plant.

Especially it is possible that the water purification plant 1 is used for the final and/or concluding treatment and/or purification of the water A to be treated and/or purified.

Equally it is possible that the total water purification plant as such, in which the water purification plant 1 is integrated, comprises at least one processing and/or treatment facility, especially a plurality of preparation and/or treatment facilities, preferably as defined above.

In this connection it is possible that the further processing and/or treatment facility of the total water purification plant comprises or consists of at least one—especially mechanical—preliminary and/or coarse filter facility and/or at least one flocculation and/or sedimentation facility and/or at least one—especially mechanical—fine filter facility and/or at least one basic adsorption facility.

Especially it is possible that the further processing and/or treatment facility of the total water purification plant comprises (i) at least one—especially mechanical—preliminary and/or coarse filter facility, (ii) at least one flocculation and/or sedimentation facility, (iii) at least one—especially mechanical—fine filter facility, and (iv) optionally at least one basic adsorption facility, especially in the above order (i) to (iv), based on the process and/or operational direction.

In this connection and in accordance with the invention it is possible that the water purification plant 1 is configured in such a way that the water A to be treated and/or purified, before supply and/or feed into the peak load adsorption facility 3 and before supply and/or feed into the main adsorption facility 2 and/or before supply and/or feed into the water purification plant 1, is first guided and/or passed (i) through and/or into the—especially mechanical—preliminary and/or coarse filter facility and/or (ii) through and/or into the flocculation and/or sedimentation facility and/or (iii) through and/or into the mechanical fine filter facility and/or (iv) through and/or into the basic adsorption facility.

In accordance with the invention it is possible that the water purification plant 1 comprises at least one contamination measuring facility 4, especially for measuring and/or capturing the concentration limit, especially incoming concentration limit. In this connection it is possible that the contamination measuring facility 4 is arranged upstream of the peak load adsorption facility 3 and of the main adsorption facility 2.

In general it is possible that the water purification plant 1 also, moreover, comprises at least one transport facility 5a, 5b, Sc, 5d, especially pipeline facility, especially for transporting the water A to be treated and/or purified and/or the treated and/or purified water B. In this case the transport facility 5a, 5b, Sc, 5d may serve to transport the water A to be treated or purified, and/or the treated or purified water B.

In general it is possible that the first transport facility 5a is connected to the main adsorption facility 2, especially to the entry of the main adsorption facility 2, the connection especially being connectable and/or regulatable, preferably engageable and disengageable.

Equally it is possible in accordance with the invention that the second transport facility 5b is connected to the first transport facility 5a and/or especially where the second transport facility 5b is connected to the peak load adsorption facility 3, especially to the entry of the peak load adsorption facility 3, the connection especially being connectable and/or regulatable, preferably engageable and disengageable.

It is possible in accordance with the invention, moreover, that the third transport facility 5c is connected to the first transport facility 5a, especially downstream of the connection of the second transport facility 5b to the first transport facility 5a, and/or especially where the third transport facility 5c is connected to the peak load adsorption facility 3, especially to the outlet of the peak load adsorption facility 3, the connection especially being connectable and/or regulatable, preferably engageable and disengageable.

In general it is possible that the fourth transport facility 5d is connected to the main adsorption facility 2, especially to the outlet of the main adsorption facility 2.

It may be the case, moreover, in accordance with the invention that the water purification plant 1 comprises at least one regulating facility 6a, 6b, 6c, especially flow regulating facility, especially valve facility, preferably a plurality of regulating facilities 6a, 6b, 6c, preferably a first regulating facility 6a, a second regulating facility 6b, and a third regulating facility 6c. The relevant regulating facility 6a, 6b, 6c serves in particular for the engagement and/or upstream insertion and/or for the disengagement of the peak load adsorption facility 3.

In general the regulating facility or facilities 6a, 6b, 6c are arranged on the transport facilities 5a, 5b, 5c, especially on the first transport facility 5a and/or on the second transport facility 5b and/or on the third transport facility 5c. By this means it is possible to regulate accordingly the flow of the water A to be treated and/or purified through the first transport facility 5a and/or through the second transport facility 5b and/or through the third transport facility 5c. By this means, moreover, it is possible to regulate the flow or stream of the water A to be treated and/or purified through the peak load adsorption facility 3 and/or through the main adsorption facility 2.

In general it is possible that the first regulating facility 6a is arranged on the first transport facility 5a and the second regulating facility 6b is arranged on the second transport facility 5b and the third regulating facility 6c is arranged on the third transport facility 5c.

It is possible, moreover, that the first regulating facility 6a is arranged parallel (i.e., in particular fluidically parallel) to the second regulating facility 6b, the peak load adsorption facility 3, and the third regulating facility 6c.

Moreover it is possible that the second regulating facility 6b is arranged upstream of the peak load adsorption facility 3, and the third regulating facility 6c is arranged downstream of the peak load adsorption facility 3.

In general it is possible that the regulating facilities 6a, 6b, 6c are configured as bypass switching and/or bypass regulation, especially for the engagement and/or upstream insertion of the peak load adsorption facility 3.

It is possible, moreover, that the water purification plant 1 comprises at least one control facility 7, especially for controlling the regulating facilities 6a, 6b, 6c.

In accordance with the invention, moreover, it may be the case that the peak load adsorption facility 3 comprises a plurality of peak load adsorption filter subunits 3a, 3b, 3c. In this connection it is possible that the peak load adsorption facility 3 is subdivided by the/into the peak load adsorption filter subunits 3a, 3b, 3c.

Moreover it is possible that the peak load adsorption filter subunits 3a, 3b, 3c in the peak load adsorption facility 3 are arranged and/or connected parallel to one another, especially fluidically parallel to one another. It is possible as a result to guide at least a divisional stream of the water to be treated or purified that is guided through the peak load adsorption facility 3 through the respective peak load adsorption filter subunits 3a, 3b, 3c.

In general it is possible that the peak load adsorption facility 3 comprises at least 2 and/or especially 2 to 10, preferably 2 to 8, more preferably 3 to 6, very preferably 5, peak load adsorption filter subunits 3a, 3b, 3c.

Especially it is possible that the peak load adsorption filter subunits 3a, 3b, 3c, independently of one another, are, or are configured in such a way as to be, engageable and disengageable.

In general it is possible that the main adsorption facility 2 also comprises a plurality of main adsorption filter subunits 2a to 2f.

In accordance with the invention it is possible that the main adsorption facility 2 is subdivided by the/into the main adsorption filter subunits 2a to 2f.

In this connection it is possible that the main adsorption filter subunits 2a to 2f are arranged and/or connected in the main adsorption facility 2 parallel to one another, especially fluidically parallel to one another, especially such that at least a divisional stream of the water A to be treated and/or purified that is guided through the main adsorption facility 2 can be guided through the respective main adsorption filter subunits 2a to 2f.

In general it is possible that the main adsorption facility 2 comprises at least 2 and/or especially 2 to 30, preferably 4 to 20, more preferably 5 to 15, very preferably 10, main adsorption filter subunits 2a to 2f.

In accordance with the invention it is possible that the main adsorption filter subunits 2a to 2f, independently of one another, are, or are configured in such a way as to be, engageable and disengageable.

In accordance with the invention it is possible that the water purification plant 1 according to the invention comprises at least one further engageable peak load adsorption facility 3′.

In general it is possible that the particulate adsorption material, especially the particulate activated carbon, preferably the granular activated carbon, more preferably the spherical activated carbon, of the peak load adsorption facility 3 is a particulate adsorption material, especially a particulate activated carbon, preferably a granular activated carbon, as defined above within the context of the method according to the invention.

It is possible, moreover, that the particulate adsorption material, especially the particulate activated carbon, preferably the granular activated carbon, more preferably the spherical activated carbon, of the main adsorption facility 2 is a particulate adsorption material, especially a particulate activated carbon, preferably a granular activated carbon, as defined above.

According to the present aspect, moreover, the present invention relates to a water processing plant 1, especially for preferably continuous treatment and/or purification of water A, especially raw, untreated water, polluted with contaminants, especially organic contaminants, preferably micronoxiants and/or trace substances, preferably for purposes of recovering and/or obtaining treated and/or purified water B, especially clean water, preferably tap water and/or service water, preferably water processing plant 1 for implementing a method according to the invention and/or preferably water processing plant 1 as defined above,

where the water processing plant 1 is intended and/or configured for adsorptive removal of contaminants from the water A to be treated and/or purified, preferably in the case of concentration increases of the contaminants, especially those occurring for a limited time and/or spontaneously, in the water A to be treated and/or purified,

where the water purification plant 1 comprises at least one main adsorption facility 2 and at least one peak load adsorption facility 3 which is disposed upstream of the main adsorption facility 2 and can be engaged in dependence on a mandated concentration limit, especially on a mandated incoming concentration limit, of the contaminants in the water A to be treated and/or purified.

According to the present aspect, additionally, the present invention also relates to a water processing plant 1, especially for preferably continuous treatment and/or purification of water A, especially raw, untreated water, polluted with contaminants, especially organic contaminants, preferably micronoxiants and/or trace substances, preferably for purposes of recovering and/or obtaining treated and/or purified water B, especially clean water, preferably tap water and/or service water, preferably water processing plant 1 for implementing a method according to the invention and/or preferably water processing plant 1 as defined above, where the water purification plant 1 comprises at least one main adsorption facility 2 and at least one peak load adsorption facility 3 which is disposed upstream of the main adsorption facility 2 and can be engaged in dependence on a mandated concentration limit, especially on a mandated incoming concentration limit, of the contaminants in the water A to be treated and/or purified.

The present invention further relates—according to the present aspect of the invention—also to a total water purification plant (also referred to synonymously as total water processing plant), especially for preferably continuous treatment and/or purification of water A, especially raw, untreated water, polluted with contaminants, especially organic contaminants, preferably micronoxiants and/or trace substances, preferably for purposes of recovering and/or obtaining treated and/or purified water B, especially clean water, preferably tap water and/or service water, preferably total water purification plant for implementing the above-defined method, where the total water purification plant comprises at least one water processing plant 1 as defined above.

The total water purification plant according to the invention may comprise at least one processing and/or treatment facility.

In this case it is possible that the processing and/or treatment facility comprises or consists of at least one—especially mechanical—preliminary and/or coarse filter facility and/or at least one flocculation and/or sedimentation facility and/or at least one—especially mechanical—fine filter facility and/or at least one basic adsorption facility.

Especially it is possible that the further processing and/or treatment facility comprises (i) at least one—especially mechanical—preliminary and/or coarse filter facility, (ii) at least one flocculation and/or sedimentation facility, (iii) at least one—especially mechanical—fine filter facility, and (iv) optionally at least one basic adsorption facility, especially in the above order (i) to (iv), based on the process and/or operational direction.

With preference in accordance with the invention the water purification plant (1) is arranged downstream at the last position and/or at the end of the total water purification plant and/or downstream of the processing and/or treatment facility and/or is inserted downstream of the processing and/or treatment facility.

The present invention further relates—according to a further aspect of the present invention—as well to the inventive uses, as indicated below: Hence the present invention relates to the use of a water processing plant, as defined above, for preferably continuous treatment and/or purification of water, especially raw, untreated water, polluted with contaminants, especially organic contaminants, preferably micronoxiants and/or trace substances, preferably for purposes of recovering and/or obtaining treated and/or purified water, especially clean water, preferably tap water and/or service water.

In this context the present invention is also directed to the aforesaid use for adsorptive removal of the contaminants from the water to be treated and/or purified, preferably in the case of concentration increases of the contaminants, especially those occurring for a limited time and/or spontaneously, in the water to be treated and/or purified.

Moreover, the present invention also relates to the use of a water processing plant as defined above as part of a total water purification plant for preferably continuous treatment/purification of water polluted with contaminants, especially as part of a total water purification plant as defined above.

Moreover, the present invention also relates to the use of a water processing plant as defined above, for attenuating and/or for evening-out concentration increases, especially those occurring for a limited time and/or spontaneously, of contaminants in water to be treated and/or purified.

Moreover, the present invention also relates to the use of a water processing plant as defined above for retrofitting and/or supplementing existing water purification plants and/or water purification apparatuses, especially for retrofitting and/or supplementing existing water purification plants and/or water purification apparatuses for continuous treatment and/or purification of water, especially raw, untreated water, polluted with contaminants, especially organic contaminants, preferably micronoxiants and/or trace substances.

In this connection the present invention is also directed to the aforesaid use for increasing and/or extending the service life of the existing water purification plants and/or water purification apparatuses.

Moreover, the present invention also relates to the use of a peak load adsorption facility 3 as defined above, especially in the preferably continuous treatment and/or purification of water A, especially raw, untreated water, polluted with contaminants, especially organic contaminants, preferably micronoxiants and/or trace substances, preferably for purposes of recovering and/or obtaining treated and/or purified water B, especially clean water, preferably tap water and/or service water, as part of a water purification plant 1 intended for the adsorptive removal of the contaminants and comprising at least one main adsorption facility 2 and at least one peak load adsorption facility 3 which can be engaged in dependence on a mandated concentration unit, especially on a mandated incoming concentration limit, of the contaminants in the water A to be treated and/or purified, and which is arranged upstream of the main adsorption facility 2,

for attenuating and/or for evening-out concentration increases, especially those occurring for a limited time and/or spontaneously, of contaminants in water to be treated and/or purified; and/or

for increasing and/or extending the service life of the main adsorption facility 2 and/or of the water purification plant 1 overall.

In the context of the aforesaid use it is possible that the water A to be treated and/or purified is supplied to the main adsorption facility 2 and is treated and/or purified in the main adsorption facility 2, in particular by the contaminants being adsorptively removed at least substantially completely in the main adsorption facility 2, especially in such a way that the concentration of the contaminants is lowered below a mandated outgoing concentration limit, and

where on exceedance of the mandated concentration limit, especially of the mandated incoming concentration limit, of the contaminants in the water A to be treated and/or purified, the peak load adsorption facility 3 is engaged and/or inserted upstream of the main adsorption facility 2, in such a way that the water A to be treated and/or purified is supplied at least partially, preferably completely, first to the peak load adsorption facility 3 and is treated and/or purified in the peak load adsorption facility 3, in particular by the contaminants being adsorptively removed at least partially, preferably by the concentration increase of the contaminants being attenuated and/or evened out.

The present invention is elucidated in more detail in the text below with reference to preferred working examples and to drawings or figures that represent embodiments, in particular also in comparison to noninventive (comparative) embodiments. In connection with the elucidation of these preferred working examples of the present invention, although these are not restrictive in any way on the present invention, further advantages, properties, aspects, and features of the present invention are also indicated.

In the figures:

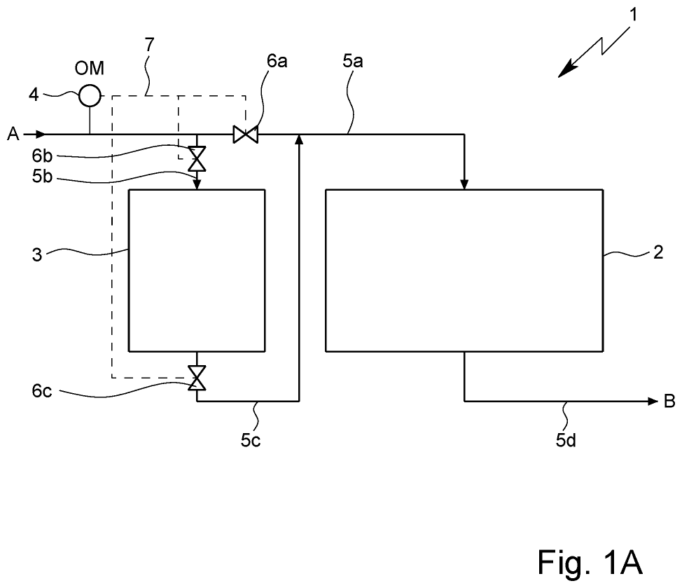

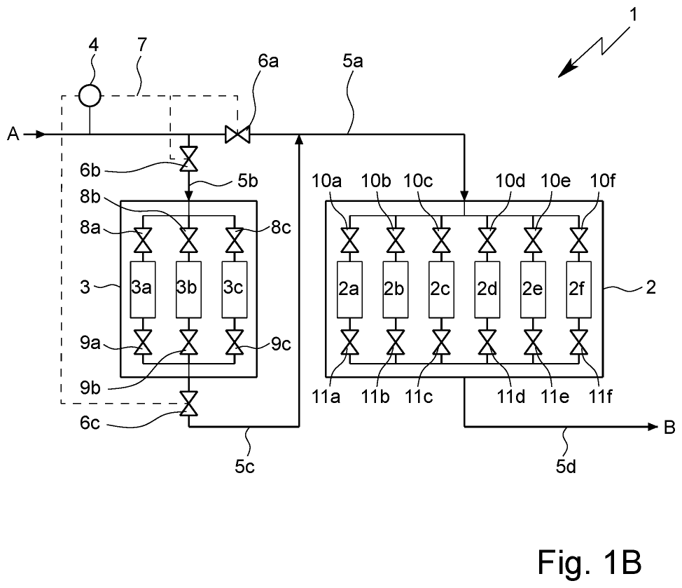

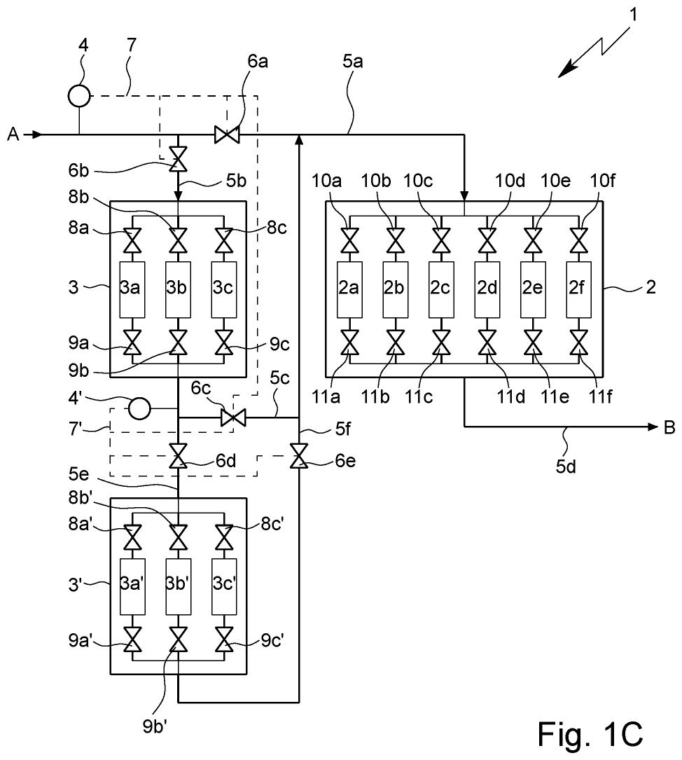

FIG. 1A shows a schematic diagram or overview of an inventive method and also of a water purification plant, underlying the method of the invention, according to the invention in one inventive embodiment, whereby the water purification plant comprises a main adsorption facility and a peak load adsorption facility which can be inserted upstream of the main adsorption facility;

FIG. 1B shows a schematic diagram or overview of an inventive method and, respectively, of a further water purification plant, underlying the method of the invention, according to the invention, whereby the peak load adsorption facility comprises corresponding peak load adsorption filter subunits and the main adsorption facility comprises corresponding main adsorption filter subunits;

FIG. 1C shows a schematic diagram or overview of an inventive method and, respectively, of yet a further water purification plant, underlying the method of the invention, according to the invention, whereby the water purification plant comprises a further peak load adsorption facility with associated peak load adsorption filter subunits;

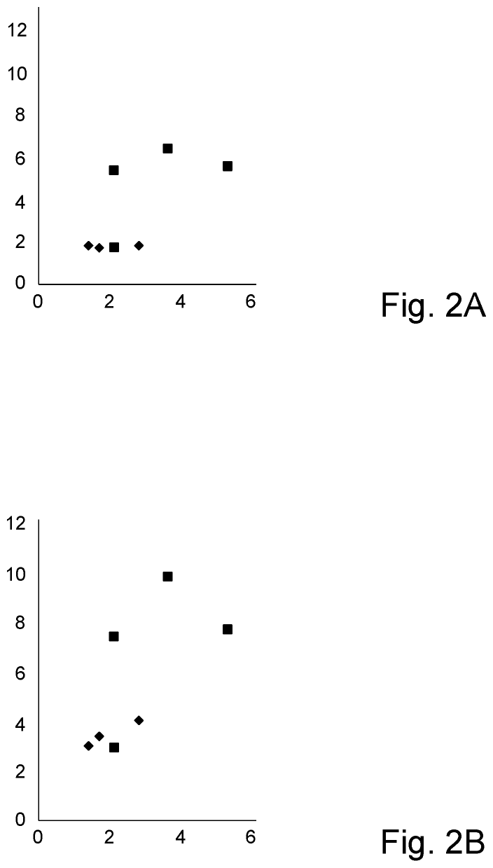

FIG. 2A shows a graph of the specific capacity or the loading amount of the pesticide metaldehyde in relation to the adsorption material or medium used, in the form of a specific spherical activated carbon, for different incoming concentrations of the substance (metaldehyde) to be adsorbed (data points shown as diamonds=constantly low incoming metaldehyde concentration of 0.1 μg/l, and data points shown as squares=constantly high incoming metaldehyde concentrations of 0.5 μg/l with additional concentration peaks of 2 μg/l for six hours) at the breakthrough point or value c>0.01 μg/l (start of breakthrough) and for rising dwell times (empty bed contact time (EBCT)); the x-axis indicates the dwell time (min), and the y-axis indicates the specific capacity in relation to metaldehyde (mg_{metaldehyde}/l_{medium});

FIG. 2B shows a graph corresponding to FIG. 2A, but at the breakthrough point or value c>0.05 μg/l (target value);

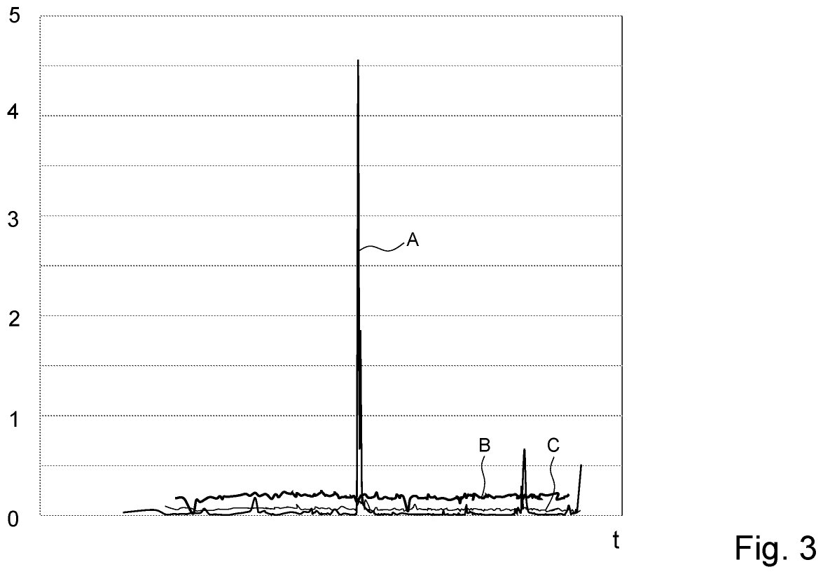

FIG. 3 shows a graph of concentration profile of metaldehyde in different untreated water sources A, B, C, as may be processed in relevant water purification plants, with the x-axis showing the time profile and the y-axis indicating the concentration of metaldehyde (μg/l);

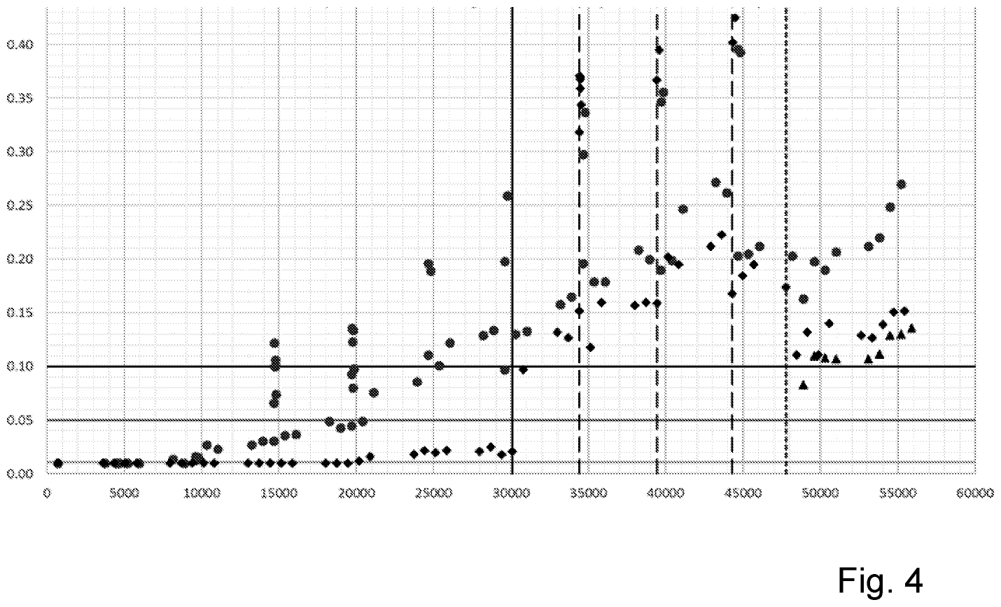

FIG. 4 shows a graph for illustrating the presence of unwanted desorption of metaldehyde for a single-stage adsorptive purification operation using different or individual trial columns and/or without deploying an engageable peak load adsorption facility (comparative), where the x-axis indicates the bed volume (BV) and where the y-axis indicates the absolute concentration of metaldehyde (g/l) at the outflow or outlet of the respective trial column (circular data point representation=first trial column; diamond-shaped data point representation=second trial column; triangular data point representation=concentration of metaldehyde at the entry of the respective column (without concentration increases present or after discharged concentration increases); the lines extending parallel to the x-axis show, from top to bottom, also (i) the mandated metaldehyde limit (using a PCV (permissible concentration value) or a guideline health value (GHV)), (ii) the mandated metaldehyde target value, and (iii) the metaldehyde detection limit, and the lines extending parallel to the y-axis show, from left to right, also (i) the starting point of the implementation or of the presence of concentration increases, (ii) the presence of corresponding concentration rises (following three lines in long-dashed representation), and (iii) the cessation of the implementation or of the presence of concentration increases (following right-hand line in short-dash representation).

FIG. 1 is therefore a schematic diagram of a preferred embodiment of the method of the invention or of the water purification plant 1 according to the invention, as described in further detail below:

In particular, FIG. 1 shows the inventive water purification plant 1, which is used in particular for preferably continuous treatment and/or purification of water A polluted with contaminants, especially organic contaminants, preferably micronoxiants and/or trace substances, preferably for purposes of recovering and/or obtaining treated and/or purified water B, or for implementing the method of the invention. In this context, the inventive water processing plant 1 is intended and/or configured for adsorptive removal of contaminants from the water A to be treated and/or purified, preferably in the case of concentration increases of the contaminants, especially those occurring for a limited time and/or spontaneously, in the water A to be treated and/or purified.

As illustrated by FIG. 1, the water purification plant 1 according to the invention comprises at least one main adsorption facility 2 and at least one peak load adsorption facility 3 which is arranged upstream of the main adsorption facility 2 and is engageable in dependence on a mandated concentration limit, especially on a mandated incoming concentration limit, of the contaminants in the water A to be treated and/or purified. The mandated concentration limit, especially incoming concentration limit, can here be measured or captured in particular upstream of the peak load adsorption facility 3 and of the main adsorption facility 2, and/or at the inlet of the inventive water purification plant 1, using, for example, a contamination measuring facility.

The inventive water purification plant 1 is configured, moreover, in such a way that the water A to be treated and/or purified is supplied to the main adsorption facility 2 and is treated and/or purified in the main adsorption facility 2, in particular in such a way that the concentration of the contaminants is lowered below a mandated outgoing concentration limit, which can be measured or captured in particular downstream of the main adsorption facility 2.

The inventive water purification plant 1 is distinguished, moreover, by a specific configuration whereby, on exceedance of the mandated concentration limit, especially of the mandated incoming concentration limit, of the contaminants in the water A to be treated and/or purified, the peak load adsorption facility 3 is engaged and/or inserted upstream of the main adsorption facility 2, in such a way that the water A to be treated and/or purified is supplied at least partially, preferably completely, first to the peak load adsorption facility 3 and is treated and/or purified in the peak load adsorption facility 3, preferably by the concentration increase of the contaminants being attenuated and/or evened out (i.e., before the water A to be treated and/or purified is supplied subsequently to the main adsorption facility 2).

In this connection, FIG. 1 also illustrates the method of the invention whereby the contaminants are removed adsorptively from the water A to be treated and/or purified, preferably in the case of increases in concentration of the contaminants, especially those occurring for a limited time or spontaneously, in the water A to be treated and/or purified, where, in accordance with the invention, indeed, the procedure in particular is that on exceedance of the concentration limit in question, especially of the mandated incoming concentration limit, of the impurities in the water A to be treated and/or purified, the peak load adsorption facility 3 is engaged and/or inserted upstream of the main adsorption facility 2, in such a way that the water A to be treated and/or purified is supplied at least partially, preferably completely, first to the peak load adsorption facility 3 and is treated and/or purified in the peak load adsorption facility 3, in particular by the contaminants being adsorptively removed at least partially, and preferably by the increase in concentration of the contaminants being attenuated and/or evened out.

After corresponding travel through the peak load adsorption facility 3, the water A to be treated and/or purified is then subject to further/downstream purification in the main adsorption facility 2, whereby it is intended in particular, indeed, that the water to be treated and/or purified is supplied to the main adsorption facility 2 and is treated and/or purified in the main adsorption facility 2, where the contaminants are adsorptively removed at least substantially completely, more particularly in such a way that they concentrations of the contaminants is lowered beneath a mandated outgoing concentration limit.

In the event of a shortfall or nonattainment of the mandated concentration limit, especially incoming concentration limit, the inventive method is geared in particular to direct treatment or purification of the water A in the main adsorption facility 2, with disengagement or bridging-over of the peak load adsorption facility 3, which in that case, so to speak, is removed from operation (specifically until the mandated concentration limit, especially incoming concentration limit, is exceeded again).

FIG. 1B shows a further embodiment of the inventive water purification plant 1 and of the inventive method, whereby, indeed, the peak load adsorption facility 3 comprises a plurality of peak load adsorption filter subunits 3a, 3b, 3c, and the main adsorption facility 2 comprises a plurality of main adsorption filter subunits 2a, 2b, 2c, 2d, 2e, 2f, where the subunits in question are individually engageable and/or disengageable, or are configured in that way.

Moreover, FIG. 1C shows a further inventive embodiment, whereby the inventive water purification plant 1 additionally comprises a further peak load adsorption facility 3′. In this context it is envisaged in particular that the further peak load adsorption facility 3′ can be engaged in dependence on a further concentration limit of the contaminants, which is measured and/or captured in particular downstream of the first peak load adsorption facility 3, this possibility of engagement being more particularly such that on exceedance of the mandated further concentration limit, the further peak load adsorption facility 3′ is engaged and/or inserted downstream of the peak load adsorption facility 3 and inserted upstream of the main adsorption facility 2, so that the water A to be treated and/or purified, before entry or transfer into the main adsorption facility 2 and after travel through the first peak load adsorption facility 3, passes through the second or further peak load adsorption facility 3′. By this means, for example, in the case of particularly strong increases in concentration of the contaminants, a further attenuation or evening-out of the concentration increase can be achieved, especially in such a way that the mandated concentration limit, especially incoming concentration limit, is undershot after passage through the further peak load adsorption facility 3′. This results in a further relieving of the main adsorption facility 2, which in this case is inserted downstream of the further peak load adsorption facility 3′, and also in a further-improved purification of the relevant water.

With regard, furthermore, to FIG. 3 and FIG. 4, reference in relation to these figures may be made in particular, also, to the statements below in the working examples.

In summary, therefore, it is found that in accordance with the invention a powerful overall approach is provided to the treatment purification of water polluted with contaminants, such as pesticides, whereby large quantities of contaminants, in particular and even those associated with time-limited or spontaneous concentration increases, can be reliably removed from the relevant water, in conjunction with improved service lives on the part of the water purification plants employed for this purpose.

Further configurations, adaptations, variations, modifications, details, and advantages of the present invention are immediately apparent to and realizable by the person skilled in the art, on reading the description, without departing the realm of the present invention.

The present invention is illustrated by the working examples which follow, but these are not intended to restrict the present invention in any way.

### Working Examples

1. Different Plants and Different Methods for Water Treatment/Purification

The text below refers to further investigations on different plants for water processing, using different methods for water treatment/purification, in relation to the treatment/purification of raw, untreated water, polluted with contaminants in the form of the pesticide metaldehyde, especially with regard to the presence of time-limited or spontaneous increases in concentration of metaldehyde in the raw water.

Also noteworthy in this context is that metaldehyde, which in the present case is also representative of pesticides as such, is particularly suitable for assessing the purification properties of a purification plant/corresponding methods, especially since the prescribed limits for metaldehyde are low. Hence the permitted maximum concentration for metaldehyde is c<0.1 μg/l, a value which ought not to be exceeded (cf. permissible concentration value or PCV, or guideline health value or GHV). Moreover, the target value is c<0.05 μg/l. The relevant limits are in particular also derived from the plan of action of the European Union for the securement of water quality.

Details of the investigations in question:
a) A first water purification plant (Plant I, comparative) is constructed in such a way that the water to be treated/purified passes first through a mechanical preliminary or coarse filter facility, next through a flocculation/sedimentation facility, in turn again through a mechanical fine filter facility, and lastly through a basic adsorption facility, with the concluding basic adsorption facility comprising a conventional shaped activated carbon based on coconut shells.

This water purification plant has a maximum daily water throughput of 36 000 m³/d.

This water purification plant is operated with raw water (especially in the form of a mixture) from various sources, as also indicated in FIG. 3, and the relevant raw water is polluted for a limited times with particularly high concentrations/amounts of metaldehyde, a possible consequence, for example, of heavy rainfall in the winter months. Accordingly, the raw water for the purification comprises time-limited and spontaneous concentration increases or rises of the pesticide metaldehyde, as also shown in FIG. 3.

For purposes of removal of metaldehyde, the water to be purified is guided through the water purification plant, with the water passing in succession through the respective purification stages with the eventual basic adsorption facility.

However, it is found here that the metaldehyde cannot be removed/separated from the raw water to a satisfactory degree using the present procedure or the plant employed for the purpose, under the auspices of drinking water processing, not even in the last purification step with the use of a basic adsorption facility based on conventional activated carbon.

The service life of the plant presently under investigation, moreover, is only low, being specifically less than 10 000 BV or <10 000 BV. In the treated water, moreover, relatively high breakthroughs of metaldehyde are observed, which authoritatively correlate with the presence of sudden increases in metaldehyde concentration in the raw water.

After the respective concentration increases or rises have subsided or been traversed, moreover, there is excessive desorption of previously adsorbed metaldehyde, as a consequence, in particular, of the sudden concentration drop of the contaminants in the water to be treated/worked up, with the attendant establishment of a new chemical equilibrium between free metaldehyde in the water and metaldehyde bound on the activated carbon.

All in all, therefore, on the basis of the present water purification plant, it is not possible for there to be effective purification of the relevant raw water, especially with regard to the management of concentration increases of the present kind, and so for this reason as well the corresponding contamination limits, as indicated above, often cannot be complied with or fulfilled.
b) Furthermore, investigations are carried out on a further water purification plant (Plant II, comparative), which in terms of construction corresponds to the above-indicated plant I, with the proviso that a further basic adsorption facility is arranged downstream of the basic adsorption facility or inserted downstream of the first basic adsorption facility. In this case the second basic adsorption facility as well comprises a conventional shaped activated carbon based on coconut shells.

The relevant water purification plant is operated in a manner corresponding to that indicated above for plant I. Relative to plant I, the presently investigated plant II has a slightly improved service life, specifically of <15 000 BV. With the water processing plant as per plant II as well, however, spontaneous increases in concentration of metaldehyde in the raw water are accompanied by unwanted breakthroughs in the treated water. With the present water purification plant as well, moreover, there is the problem of desorption after traversal of individual concentration increases of metaldehyde, and overall, therefore, the relevant plant II does not fulfil the exacting requirements in relation to the removal of metaldehyde, especially metaldehyde present in the context of concentration increases.
c) In a corresponding way, investigations are carried out on a further water purification plant (Plant III, comparative), with the presently investigated plant III corresponding to the above-indicated plant II, with the proviso that after the basic adsorption facilities, and specifically downstream of the second basic adsorption facility and therefore, so to speak, as the last downstream-arranged purification facility, there is a further adsorption facility used.

The last downstream-arranged adsorption facility here comprises a high-performance activated carbon in the form of a spherical activated carbon (average particle diameter about 0.4 mm, specific surface area (BET surface area) about 1700 m²/g; iodine number about 1600 mg/g; tapped or tamped density about 490 kg/m³; ash content about 0.2 wt %; water content about 0.1 wt %; abrasion hardness or abrasion strength about 99%). The present tap water purification plant as per plant III is also operated in a manner corresponding to the statements above, and so for the present water purification plant as well, therefore, the raw water introduced is a water polluted with contaminants in the form of metaldehyde, for which the relevant noxiant is again also obtained or present in the form of time-limited or spontaneous concentration increases, as indicated above.

The presently investigated tap water purification plant has a service life of <20 000 BV. In spite of a slight reduction in the risk of spontaneous breakthroughs in the case of a concentration increase of metaldehyde being present, plant III is nevertheless subject to corresponding breakthroughs at the outlet of the plant and/or in the treated water, these breakthroughs again correlating with the presence of respective concentration peaks. Equally, also, desorption of metaldehyde is observed after traversal of the concentration increase in the treated water and/or at the outlet of the adsorption stage.
d) Investigated lastly is a further water processing plant (Plant IV, inventive) to implement an inventive method. The inventive water purification plant as per plant IV corresponds to the aforesaid plant I, with the proviso that downstream of the basic adsorption stage there is a main adsorption facility and also there is a peak load adsorption facility which is arranged upstream of the main adsorption facility and downstream of the basic adsorption stage and which can be engaged in dependence on a mandated concentration limit, especially on a mandated incoming concentration limit, of the contaminants in the water to be treated and/or purified. Presently both the peak load adsorption facility and the main adsorption facility are equipped with the high-performance activated carbon already used for the aforesaid plant III, in the form of a spherical activated carbon having the relevantly indicated properties. In this regard, reference may be made to the statements in section c).

The inventive plant IV, moreover, comprises a contamination measuring facility, where the mandated concentration limit, especially the mandated incoming concentration limit, is captured/measured at the inlet of the plant. This measurement/capture of the incoming concentration limit may take place in the form of an online measurement. The mandated entry concentration limit, especially incoming concentration limit, is mandated, for the purposes of the present investigation, with a value of 0.1 μg/l, and so on exceedance of the relevant value (i.e., in the presence of a concentration increase), the peak load adsorption stage is engaged, and is disengaged when the value falls below the relevant value.

The peak load adsorption facility here can be engaged/disengaged via corresponding regulating facilities, and in the engaged state or on exceedance of the mandated concentration limit, especially incoming concentration limit, the procedure followed is such that, with engagement of the peak load adsorption facility, the water to be treated and/or purified, after passing through the basic adsorption facility (and also the further processing and/or treatment facilities or purification stages inserted upstream of the basic adsorption facility), is guided first through the peak load adsorption facility and subsequently through the main adsorption facility.

Moreover, on undershooting of the mandated concentration limit, especially incoming concentration limit, the peak load adsorption facility is disengaged again (and remains in an engageable state), and so, on undershooting of the relevant limit, the water to be purified and/or treated is guided directly from the basic adsorption facility into the main adsorption stage, with omission or bridging-over of the peak load adsorption facility.

In relation to the inventive water purification plant, therefore, the approach of the invention is employed, whereby, so to speak, as part of tap water processing, use is made, as downstream purification (i.e., after passage of the water to be purified through the basic adsorption facility and also through the further processing and/or treatment facilities and/or purification stages inserted upstream of the basic adsorption facility) of a main adsorption facility having a peak load adsorption facility which is designed in particular in the manner of an upstream-insertable “Firewall”, with the peak load adsorption facility being inserted upstream of the main adsorption facility, for the targeted interception of peak load concentrations, and so the peak load adsorption stage is used/engaged as and when required, on exceedance of the relevant concentration limit.

The inventive water purification plant in question as per plant IV is operated in a manner corresponding to the above-indicated plants. The situation here in particular is such that on undershooting of the relevant incoming concentration of metaldehyde (i.e., on undershooting of an incoming concentration of 0.1 μg/l), the water to be purified is guided into the main adsorption stage, with circumvention or bridging-over of the peak load adsorption stage, and in the main adsorption stage the concentration is reduced below the target value of 0.05 μg/l.

On exceedance of the entry concentration of 0.1 μg/l, which occurs together with the presence of a time-limited or spontaneous increase in the concentration of metaldehyde, the peak load adsorption facility is engaged upstream of the main adsorption facility, so that only the peak load adsorption facility is loaded with high concentrations of metaldehyde, this being associated with a corresponding evening-out or reduction of the metaldehyde concentration, with the consequence that the downstream main adsorption facility is loaded with correspondingly reduced concentrations of metaldehyde.

The situation here is in particular such that in the upstream-inserted peak load adsorption facility, the concentration of the contaminants can be lowered beneath the limit of 0.1 μg/l, and that, in the main adsorption facility arranged subsequently, the prepurified water is further processed/finalized, specifically such that in the main adsorption facility the concentration of the contaminants is reduced beneath the limit of 0.05 μg/l.

In this way, in accordance with the invention, a very high service life is achieved, which specifically for the inventive plant IV is >30 000 BV. Furthermore, the incidence of breakthroughs of contaminants at the outlet of the main adsorption facility or water purification plant is prevented overall, even in the presence of high entry concentrations or concentration increases, this being the case in particular to the effect that even when high entry concentrations are present, the purified water ultimately obtained has a metaldehyde concentration beneath the target value of 0.05 μg/l.

Within the design approach taken by the invention, therefore, outstanding purification outcomes are realized at the same time as significantly extended service lives on the part of the relevant water purification plant according to the invention.

2. High Entry Concentrations Lead to High Adsorption Capacities

On the basis of experimental investigations, the applicant is able to show, surprisingly, that especially for the high-performance adsorbents which are used preferredly in accordance with the invention, of the kind also used, for example, in the above-indicated inventive water purification plant as per plant IV, high entry concentrations of contaminants, such as metaldehyde, lead to high adsorption capacities of the relevant activated carbon, as shown in particular in FIG. 3A and also FIG. 3B.

From FIG. 3A and FIG. 3B, respectively, it is apparent that low entry concentrations lead to low capacities or to low amounts of adsorbed metaldehyde, whereas high entry concentrations lead to high capacities or high amounts of adsorbed metaldehyde.

For this reason as well, high capacities are achieved for the peak load adsorption facility which is engaged on exceedance of a correspondingly high concentration limit, especially incoming limit, in accordance with the approach of the invention, and hence even small volumes or small amounts of adsorption material lead to an outstanding adsorption performance on the part of the peak load adsorption facility. Furthermore, the approach of the invention, with the treatment first in the peak load adsorption facility and subsequently in the main adsorption facility in the case of the presence of high incoming concentrations, is accompanied by the advantage that there is no need, in relation to the engaged peak load adsorption facility, to reduce the target concentration hereby to a value of less than 0.05 μg/l, the requirement instead being merely to reduce it to a value of, for example, less than 0.1 μg/l, since the water to be purified is subsequently passed through the main adsorption facility as well, where it is further purified. Accordingly, the peak load adsorption facility can be given a correspondingly smaller sizing or else in this regard a greater potential of the adsorption material employed therein can be exploited.

3. Concentration Drop Leads to Desorption

As indicated above for the comparative water purification plants as per plant I to III, the risk which has existed to date is that of the unwanted release of contaminants or metaldehyde through desorption after traversal of the concentration increase and/or on falls in the incoming concentration of the contaminants to a normal level.

In this context, the incidence of desorption of metaldehyde, for example, means that previously adsorbed metaldehyde is dissolved back from the adsorption material into the water. Without wishing to be restricted to this theory or to insist on it, the basis for this effect is that a new chemical equilibrium is established between metaldehyde adsorbed on the adsorption material and metaldehyde dissolved in the water. Where, in this context, there is a large amount of metaldehyde at or on the adsorption material and a small amount or concentration in the water, a correspondingly large amount of metaldehyde dissolves from the adsorption material, and so there is a new equilibrium with release of hitherto bound metaldehyde, with the relevant desorption problems being observed critically on the aforesaid comparative water purification plants.

Against this background, reference may also be made to FIG. 4. FIG. 4 shows the profile of the concentration of metaldehyde at the respective outflow from two trial columns as a function of the bed volume (cf. diamond-shaped and circular data points). The procedure in FIG. 4 is that first of all the concentration increases (lines represented in long-dash form) on attainment of a defined bed volume, namely 47 000 BV, are set (cf. right-hand line in short-dash representation), and so, after exceedance of the aforementioned bed volume, the water to be purified is guided through the respective trial columns with only a low entry concentration of metaldehyde (cf. triangular data points). In this case, however, it is found that the concentration of metaldehyde at the respective outlet does not fall further but instead—diametrally thereto—in fact rises. FIG. 4 also shows that the effect of the desorption is much more strongly pronounced in the case of a more highly loaded trial column (cf. circular data points versus diamond-shaped data points).

On the basis of the method of the invention and, respectively, the water purification plant of the invention, the danger or risk of desorption is sustainedly lowered, because the engageable peak load adsorption facility is charged only with high entry concentrations of the relevant contaminants, and the main adsorption stage is charged only with low entry concentrations.

4. Further Advantages of the Present Invention

The method of the invention and the water purification plant of the invention, respectively, are associated with the further key advantage that, as indicated above, it is possible to give precise predictions of the service life of the water purification plant and/or the main adsorption facility. Also relevant in this context is that the peak load adsorption facility engaged for high incoming or entry concentrations of the contaminants results in the main adsorption facility being operated/charged only with constantly low concentrations of contaminants, so leading to a high and, moreover, precisely predictable service life. The purposive deployment of the peak load adsorption facility in the context of the present invention therefore means that the main adsorption stage, even when high noxiant concentrations are present, is operated or charged with consistently low entry concentrations of contaminants, meaning that the service life of this stage is prolonged and, moreover, is predictable, and meaning that there are no unwanted breakthroughs of contaminants and that the risk of unwanted desorption is significantly reduced.

In this context it should be indicated in turn for the peak load adsorption facility that this facility is critically operated or charged only with high concentrations of contaminants in the presence of corresponding concentration increases, so leading to a high loading/high capacities and hence to an effective reduction in the pollution with the relevant contaminants. Moreover, there is also a significant reduction in the risk of desorption. Furthermore, as indicated above, the peak load adsorption facility is placed in operation only when this is necessary (i.e., on exceedance of the mandated concentration limit or incoming concentration limit). As a result of this as well, a relatively high level of utilization of the adsorption material employed in the peak load adsorption facility is possible.

All in all, therefore, the present investigations and statements show the outstanding properties of the method of the invention and also of the corresponding water purification plant, and, respectively, of the relevant total water purification plant according to the invention, in relation also to the adsorbents which are employed specifically in accordance with the invention, in the form of activated carbon, especially spherical activated carbon.

### LIST OF REFERENCE SYMBOLS

1 water purification plant
2 main adsorption facility
2a-f main adsorption filter subunits
3 peak load adsorption facility
3a-c further peak load adsorption filter subunits
3′ further peak load adsorption facility
3a′-c′ peak load adsorption filter subunits of the further peak load adsorption facility
4 contamination measuring facility
4′ further contamination measuring facility
5a-f transport facilities
6a-e regulating facilities
7 control facility
7′ further control facility
8a-c further regulating facilities of the peak load adsorption filter subunits (upstream)
9a-c further regulating facilities of the peak load adsorption filter subunits (downstream)
10a-f further regulating facilities of the main adsorption filter subunits (upstream)
11a-f further regulating facilities of the main adsorption filter subunits (downstream)

1-85. (canceled)

86. A method for treatment and purification of water polluted with organic contaminants for purposes of recovering treated and purified water,
wherein the method comprises a step of removing the contaminants adsorptively from the water to be treated and purified,
wherein the water to be treated and purified is supplied to a water purification plant for adsorptive removal of the contaminants, wherein the water purification plant comprises at least one main adsorption facility and at least one peak load adsorption facility which is disposed upstream of the main adsorption facility and which can be engaged in dependence on a predetermined incoming concentration limit of the contaminants in the water to be treated and purified,
wherein the main adsorption facility comprises a fixed bed based on a particulate activated carbon in a loose bulk of the particulate activated carbon and wherein the peak load adsorption facility comprises a fixed bed based on a particulate activated carbon in a loose bulk of the particulate activated carbon,
wherein the peak load adsorption facility has a lower fixed bed filter volume than the main adsorption facility, wherein the ratio of the fixed bed filter volume of the main adsorption facility, on the one hand, to the fixed bed filter volume of the peak load adsorption facility, on the other hand, is at least 1.2:1,
wherein the residence time in the peak load adsorption facility of the water to be treated and purified is set to a lower value than in the main adsorption facility, wherein the ratio of the residence time in the main adsorption facility of the water to be treated and purified, on the one hand, to the residence time in the peak load adsorption facility of the water to be treated and purified, on the other hand, is set to a value of at least 1.2:1,
wherein the water to be treated and purified is supplied to the main adsorption facility and treated and purified in the main adsorption facility, wherein the contaminants are adsorptively removed at least substantially completely in the main adsorption facility such that the concentration of the contaminants is lowered below a predetermined outgoing concentration limit, and
wherein, on exceedance of a predetermined incoming concentration limit of the impurities in the water to be treated and purified, the peak load adsorption facility is engaged and is inserted upstream of the main adsorption facility such that the water to be treated and purified is supplied at least partially first to the peak load adsorption facility and treated and purified in the peak load adsorption facility, wherein the contaminants are adsorptively removed at least partially while attenuating and evening out a concentration increase of the contaminants.

87. The method as claimed in claim 86,
wherein treatment and purification of the water is performed continuously.

88. The method as claimed in claim 86,
wherein the method is performed in case of concentration increases of the contaminants, occurring for a limited time or spontaneously in the water to be treated and purified.

89. The method as claimed in claim 86,
wherein the main adsorption facility comprises the particulate activated carbon in the form of a granular activated carbon; and
wherein the peak load adsorption facility comprises the particulate activated carbon in the form of a granular activated carbon.

90. The method as claimed in claim 86,
wherein the ratio of the fixed bed filter volume of the main adsorption facility, on the one hand, to the fixed bed filter volume of the peak load adsorption facility, on the other hand, is at least 1.4:1.

91. The method as claimed in claim 86,
wherein the ratio of the fixed bed filter volume of the main adsorption facility, on the one hand, to the fixed bed filter volume of the peak load adsorption facility, on the other hand, is in a range from 1.2:1 to 30:1.

92. The method as claimed in claim 86,
wherein the ratio of the residence time in the main adsorption facility of the water to be treated and purified, on the one hand, to the residence time in the peak load adsorption facility of the water to be treated and purified, on the other hand, is set to a value of at least 1.4:1.

93. The method as claimed in claim 86,
wherein the ratio of the residence time in the main adsorption facility of the water to be treated and purified, on the one hand, to the residence time in the peak load adsorption facility of the water to be treated and purified, on the other hand, is set to a value in a range from 1.4:1 to 5:1.

94. The method as claimed in claim 86,
wherein, on shortfall or presence of a predetermined incoming concentration limit, the water to be treated and purified is supplied at least substantially completely to the main adsorption facility directly or with circumvention of the peak load adsorption facility and treated and purified in the main adsorption facility.

95. The method as claimed in claim 86,
wherein the water purification plant, additionally to the main adsorption facility and to the peak load adsorption facility, comprises or consists of at least one further preparation and treatment facility.

96. The method as claimed in claim 86,
wherein the water purification plant, additionally to the main adsorption facility and to the peak load adsorption facility, comprises or consists of at least one further preparation and treatment facility.
wherein the further preparation and treatment facility comprises:
(i) at least one mechanical preliminary or coarse filter facility,
(ii) at least one flocculation or sedimentation facility,
(iii) at least one mechanical fine filter facility, and
(iv) optionally, at least one basic adsorption facility.

97. The method as claimed in claim 86,
wherein the incoming concentration limit is measured or captured upstream of the peak load adsorption facility and of the main adsorption facility.

98. The method as claimed in claim 86,
wherein the incoming concentration limit is measured or captured at an upstream first position or, based on the process or operational direction, at the start or at the inlet of the water purification plant.

99. The method as claimed in claim 86,
wherein the peak load adsorption facility comprises a plurality of peak load adsorption filter subunits.

100. The method as claimed in claim 86,
wherein the peak load adsorption facility comprises a plurality of peak load adsorption filter subunits, wherein the peak load adsorption filter subunits are arranged and connected in the peak load adsorption facility parallel to one another such that through the respective peak load adsorption filter subunits it is possible to guide at least a divisional stream of the water to be treated and purified that is guided through the peak load adsorption facility.

101. The method as claimed in claim 86,
wherein the main adsorption facility comprises a plurality of main adsorption filter subunits.

102. The method as claimed in claim 86,
wherein the main adsorption facility comprises a plurality of main adsorption filter subunits, wherein the main adsorption filter subunits are arranged and connected in the main adsorption facility parallel to one another such that at least a divisional stream of the water to be treated and purified that is guided through the main adsorption facility can be guided through the respective main adsorption filter subunits.

103. The method as claimed in claim 86,
wherein the organic contaminants are at least one of micronoxiants and trace substances.

104. The method as claimed in claim 86,
wherein the organic contaminants are selected from the group of (i) agriculturally utilized and arising chemicals, pesticides, metaldehydes, fungicides and insecticides; (ii) industrially utilized and arising chemicals and industrial chemicals, plasticizers, bisphenol-A, X-ray contrast agents, amidotrizoic acids, iopamidol, surfactants, perfluorinated surfactants, antiknock agents, methyl tert-butyl ether (MTBE), Dissolved Organic Carbons (DOCs); (iii) active pharmaceutical ingredients and human and veterinary drugs, antibiotics, analgesics and active hormone ingredients.

105. The method as claimed in claim 86,
wherein the particulate activated carbon of the peak load adsorption facility and the particulate activated carbon of the main adsorption facility, independently of one another, are obtainable by carbonization and subsequent activation of a synthetic and non-naturally based starting material based on organic polymers.

106. The method as claimed in claim 86,
wherein the particulate activated carbon of the peak adsorption facility has a higher specific surface area and a higher total pore volume than the particulate activated carbon of the main adsorption facility.

107. The method as claimed in claim 86,
wherein the method comprises a continuous treatment and purification of water polluted with organic contaminants based on micronoxiants or trace substances for purposes of recovering treated and purified water.

108. The method as claimed in claim 86,
wherein the method comprises attenuating and evening-out concentration increases, limited in time or occurring spontaneously, of organic contaminants in water to be treated and purified.

109. The method as claimed in claim 86,
wherein the method comprises retrofitting or supplementing existing water purification plants or water purification apparatuses for continuous treatment and purification of water polluted with organic contaminants.

110. A water preparation plant for treatment and purification of water polluted with organic contaminants for purposes of recovering treated and purified water,
wherein the water preparation plant is configured for adsorptive removal of organic contaminants from the water to be treated and purified,
wherein it is provided to supply the water to be treated and purified to the water purification plant for adsorptive removal of the contaminants,
wherein the water purification plant comprises at least one main adsorption facility and at least one peak load adsorption facility which is disposed upstream of the main adsorption facility and which can be engaged in dependence on a predetermined incoming concentration limit of the contaminants in the water to be treated and purified,
wherein the main adsorption facility comprises a fixed bed based on a particulate activated carbon in a loose bulk of the particulate activated carbon and wherein the peak load adsorption facility comprises a fixed bed based on a particulate activated carbon in a loose bulk of the particulate activated carbon,
wherein the peak load adsorption facility has a lower fixed bed filter volume than the main adsorption facility, wherein the ratio of the fixed bed filter volume of the main adsorption facility, on the one hand, to the fixed bed filter volume of the peak load adsorption facility, on the other hand, is at least 1.2:1, and
wherein the water purification plant is configured in such a way that the residence time in the peak load adsorption facility of the water to be treated and purified is set to a lower value than in the main adsorption facility, wherein the ratio of the residence time in the main adsorption facility of the water to be treated and purified to the residence time in the peak load adsorption facility of the water to be treated and purified is set to a value of at least 1.2:1,
wherein the water purification plant is configured in such a way that the water to be treated and purified is supplied to the main adsorption facility and is treated and purified in the main adsorption facility, wherein the contaminants are adsorptively removed at least substantially completely in the main adsorption facility such that the concentration of the contaminants is lowered below a predetermined outgoing concentration limit, and
wherein the water purification plant is configured in such a way that, on exceedance of the predetermined incoming concentration limit of the contaminants in the water to be treated and purified, the peak load adsorption facility is inserted upstream of the main adsorption facility in such a way that the water to be treated and purified is supplied at least partially first to the peak load adsorption facility and is treated and purified in the peak load adsorption facility, wherein the contaminants are adsorptively removed at least partially while attenuating and evening out a concentration increase of the contaminants.

111. The water preparation plant as claimed in claim 110,
wherein the water preparation plant is configured for the continuous treatment and purification of water polluted with organic contaminants on the basis of micronoxiants or trace substances.

112. The water preparation plant as claimed in claim 110,
wherein the water preparation plant is configured for adsorptive removal of contaminants from the water to be treated and purified in the case of concentration increases of the contaminants occurring for a limited time or spontaneously in the water to be treated and purified.

113. The water preparation plant as claimed in claim 110,
wherein the water preparation plant is configured for implementing a method as claimed in claim 86.
